(19) United States
(12) Patent Application Publication
(10) Pub. No.: US 2007/0231419 A1
(43) Pub. Date: Oct. 4, 2007

(54) Process and Apparatus for Heat Transfer

(76) Inventors: Antal Pelcz, Budaors (HU); Tamas Illes, Lakhegy (HU); Zoltan Horvath, Lebeny (HU); Laszlo Simon, Budapest (HU)

Correspondence Address: YOUNG & THOMPSON, 745 SOUTH 23RD STREET, 2ND FLOOR, ARLINGTON, VA, 22202, US

(21) Appl. No.: 11/632,276

(22) PCT Filed: Apr. 21, 2006
(86) PCT No.: PCT/HU06/00030

§ 371 Date: Jan. 22, 2007

(30) Foreign Application Priority Data
May 2, 2005 (HU) P500432
Jan. 25, 2006 (HU) P0600054

(51) Int. Cl. B29C 47/88

(52) U.S. Cl. 425/72.1; 165/104.34; 425/377

(57) ABSTRACT

Process for heat transfer between a solid object and a material layer, including the steps of: a) arranging a heat-discharging surface from a heat-receiving surface at a gap (R) for the flow (4); b) generating a speed difference between the surfaces by providing a relative movement thereof; c) increasing the speed (v₁) of the flow (4) in the gap (R) compared to the speed of these surfaces (v_{H} and/or v_{F}) by the speed difference; d) maintaining a turbulent flow (4) in the gap (R) and carrying out the heat transfer by this flow (4). In the apparatus, the heat-receiving surface of the solid object (H) is formed on a structural part, e.g. rotor (2), which is relatively movably arranged in a housing (3) compared to the heat-discharging material layer (F). It is provided with a heat-removing unit and/or a heating unit.

### FIELD OF THE INVENTION

The present invention relates to a process and apparatus for heat transfer between a solid body, on the one hand, and a material layer comprising solid and/or fluid material, and in a given case gaseous particles, on the other hand.

The proposed heat transfer system can be widely used in the practice, for example for cooling or drying different material layers, such as strip-like products, e.g. foils, especially blown-up packaging foil hoses extruded from thermoplastics, paint layers, or for cooling bodies, such as electronic units, e.g. processors.

### BACKGROUND OF THE INVENTION

It is known that during the traditional plastic foil production, the temperature of the melted foil exiting from the extruder die is generally between 150° C. and 180° C., therefore the non-stabilized foil must be cooled down relatively rapidly, in the first cooling step to approx. 80° C. to 100° C. to make it solid, then in the second cooling step to a storage temperature of approx. 20° C. to 25° C. in order to prevent shrinking and to prevent foil layers from sticking together, and all this before rolling up the foil. The melted plastic material of the foil just exiting from the extruder die starts to become solid, and at the end of a stabilizing step it is substantially solid, its wall thickness is constant, that is why the evenness and intensity of the cooling play an important role in the product quality. But, at higher foil speeds, there is a relatively shorter time available for such a foil cooling. This means that presently the foil cooling is the most critical phase of the entire foil production technology.

Hungarian Patent Specification No. P-0301174 of the same applicant discloses a special foil cooling technology, wherein the foil hose—immediately after its continuous exit from a drawing aperture of the extruder die and its blown-up to a prescribed size by air—is cooled down to the prescribed temperature by driving a pressurized coolant—mainly air, fed in the area of the drawing aperture—along the internal and/or external skirt of the foil hose. The coolant is fed in the area of the drawing aperture tangentially to the foil hose in order to cool the foil hose internally and/or externally. The coolant is driven as a spiral coolant stream from the tangential inlet to the outlet by centrifugal force affecting the coolant along the internal and/or external surface of the foil hose, and by density and pressure differences between various parts of the coolant stream. An internal and/or external ring channel, with tangential inlet, delimited by a tubular skirt or mantle positioned at a radial distance from the skirt surface of the foil hose, is applied. By using this technology the efficiency of the heat transfer can be increased to a certain velocity of the coolant stream, compared to the prior solutions.

U.S. Pat. No. 6,068,462 discloses a device for continuous production of blown-up foil hoses, which device is provided with internal and external cooling units. The external cooling unit comprises cooling disc arranged adjacent to the drawing aperture of the extruder nozzle, which is provided with two channels for the coolant and radial outlets along its internal perimeter, directing the coolant streams upwards, that is, in the direction of the foil moving. At its bottom part, the external cooling disc has two radial inlets for the coolant. If the cooling air was reduced in one of the channels, then at the same time the quantity of the coolant is increased in the other channel, because always a given quantity of air was distributed into two streams. As a consequence, the rate of air quantities in the channels can be regulated only together, but this prevents a more effective control of the stream control.

A further problem of the above system lies in that the external cooling device blows in the coolant into a cooling gap only at the bottom, at a part with the smallest diameter of a cooling funnel surrounding the first non-stabilized conical part of the blown foil hose through said cooling channel, where the foil speed is relatively slow, and its diameter is also relatively small. As the foil hose moves upwards, it extends nearly parallel with the conical funnel, so its diameter continuously increases, but its wall thickness becomes smaller, and its progression speed increases. This poses the next problem that the flow cross-section of the annular cooling gap between the foil hose and the conical funnel increases multiply by the growing diameter of the blown-up foil hose, and as the radial incoming airflow from below slows down very much and this airflow warms up rapidly, consequently the efficiency of cooling deteriorates extremely. This happens in spite of the fact that, unfortunately, the size of the cooling gap between the foil hose and the conical funnel gets reduced, due to a lack of coolant, therefore local increases in the foil thickness should be taken into account, which deteriorate the product quality.

According to our experiences, when using the above apparatus, the foil is very “unstable”, although actually it is the cooling air flowing at high speed between the foil and the conical funnel that is intended “to stretch” the blown foil hose out. As a consequence, the foil is “swinging” at higher speeds what is to be eliminated. That is why, in the traditional cooling devices, the maximum applicable foil speed is about 120 m/min, which is a major hindrance to further increasing productivity.

It is known that extruded foils to be printed must be tempered in such a way that first the foil must be cooled back to environmental temperature in its entire cross-section before being rolled up, afterwards, the ensuing printing operation must be followed by drying the fluid layer of paint. In most of the cases, a known drying tunnel is applied for this drying step.

But, deficiencies of known drying tunnels include too high energy demand, on the one hand, as the layer of paint on the surface of printed foils is to be dried by high-temperature air of large volume flow rate, wherein only a small part of this air gets precisely to the printed foil surface where it is actually required. However, the softening temperature of the thermoplastic carrier foil limits the temperature of the drying air, thus the intensity of drying.

On the other hand, the painted surface of the foil may not contact with any guide rollers of the drying tunnel before complete drying, therefore the foil is guided within the drying tunnel in an uncertain manner, which limits the track speed and the drying intensity. Furthermore, a large quantity of hot air must be cooled back after the drying operation, in order to condensate the solvent out of it, which requires further expenditures. Besides, the printed and dried foil must be cooled back again in an extra cooling step to environment temperature before being rolled up for storage.

### SUMMARY OF THE INVENTION

The general object of this invention is to provide an improved and universally applicable system for heat transfer between a solid object, on the one hand, and a material layer, on the other hand, by which heat transfer can be performed more quickly, more efficiently, and more evenly than by any of the traditional technologies.

Another object of the invention is to enable especially band-type products, e.g. plastic foils, to be tempered, that is, to be cooled or dried, relatively more quickly, more evenly, and more efficiently, thus to ensure improved product quality by means of improved heat transfer conditions.

These, and other objects of the invention are achieved by the process and apparatus as disclosed below in independent claims. Further advantageous features and embodiments are mentioned in dependent claims.

So according to the this invention a process is provided for heat transfer between a solid object and a material layer comprising solid and/or liquid/fluid material, and in a given case gaseous particles, by using a heat transfer medium flow for the heat transfer between a heat-receiving surface of the solid object (or the material layer) and a heat-discharging surface of the material layer (or the solid object). The heat-receiving and heat-discharging surfaces are arranged with a distance from each other. The essence of this process lies in the following steps of:

a) Arranging the heat-discharging surface with the distance from the heat-receiving surface to provide a predetermined gap there-between for the heat-transferring medium flow;

b) Generating a predetermined speed difference between the heat-receiving and heat-discharging surfaces by providing a relative movement of the heat-receiving surface and/or the heat-discharging surface;

c) Increasing—in a predetermined manner—the speed of the heat transfer medium flow in the gap compared to the speed of the heat-receiving and/or a heat-discharging surfaces by using said speed difference;

d) Maintaining a turbulent character of the heat transfer medium stream in the gap;

e) Carrying out the heat transfer between the heat-receiving and heat-discharging surfaces at least mainly by the turbulent heat transfer medium stream.

It has also been recognized that the proposed heat transfer technology can be applied in practice in a much wider range than it was initially assumed. This heat transfer process can be applied for the tempering (e.g. cooling or drying) of e.g. extruded band-type products, particularly plastic foils. Here, the product, e.g. the foil exiting through the drawing opening of the extruder die is to be cooled down by at least one medium flow along its cooling/stabilizing section, and for this purpose, the medium flow is driven in a gap between the product wall and a delimiting mantle. The delimiting mantle, separated from the product by the gap is set into relative motion of previously specified speed compared to the cooling medium flow. Thereby the speed of the medium flow is increased to a previously specified degree, on the one hand; and the tempering of the foil is at least largely realized by heat transfer to the delimiting mantle through the high-speed turbulent medium flow, on the other hand; thirdly, the size of the gap is adjusted to be relatively reduced.

Preferably the value of the peripheral speed of the delimiting mantle of the rotor is to be selected to multiple, preferably at least fivefold of the speed of the heat-transferring medium flow.

On the other hand, the size of the annular gap can be set simply by selecting the speed of the turbulent heat-transferring medium flow in the gap. At the same time a final diameter of the blown-up foil hose can be calibrated by the turbulent heat-transferring medium flow. Preferably the size of the gap receiving the turbulent heat-transferring medium flow for tempering the thermoplastic foil hose is set at a value of maximum 1.0 mm.

According to the invention, as material of the heat-transferring medium flow may be used at least one gaseous medium, mainly air, or at least one fluid, e.g. water, or any other material capable to flow, e.g. sand, or any mix or combination thereof.

Moreover, the invented process can also be applied for drying a painted foil track, or for cooling e.g. structural units to be protected from overheating, e.g. electronic processors, or for any heat transfer tasks performed with any other heat-transferring medium.

The apparatus according to the invention comprises a heat-receiving or heat-discharging surface contacting with the heat transfer medium flow, for instance a delimiting mantle, is shaped or arranged on a solid object/structural unit of the apparatus, preferably on its rotor, or on a rotated disc or cylinder thereof, which is embedded to be capable for relative displacement in a housing, preferably in a rotatable manner, and it is connected with a motion drive, preferably with a rotary drive with controllable r.p.m. The delimiting mantle is equipped with means for removal of the heat content of the delimiting mantle taken over by the heat transfer step from the rotor and/or the housing from the equipment, and/or heating means for ensure the tempering heat required for the delimiting mantle.

The process according to the invention can also be implemented by a foil cooling apparatus arranged in the proximity of a drawing opening of an extruder, and which has a unit to lead a cooling medium flow on the product. It is provided with a delimiting mantle to delimit the gap guiding the medium flow. The delimiting mantle is arranged on a rotor, which is rotatable embedded in a housing of the apparatus, and it is preferably equipped with a rotary drive of controllable r.p.m. Furthermore, it has a unit to remove the heat of the product and/or the heat content, taken over by heat transfer through the rotor and/or the housing, from the apparatus.

Preferably the rotor has a ring-like design, and its internal mantle surface is provided with blade-like ribs or grooves being in cooperation with at least one nozzle connected to a controllable compressed air source, and forming thereby a simple pneumatic rotary drive for the rotor.

On the basis of our experience gained in the course of the plastic packing foil production experiments performed, it was clearly demonstrated that cooling back the plastic-melt just exiting from the extruder head affected the final product quality at least to the same degree as any other earlier phases of production technology. Therefore, first our technical development was concentrated on foil cooling, on the one hand, so that the results achieved in the extruder head could be completely preserved in the final product, that is, the cooling system should not deteriorate but further improve foil product quality. Essential factors for this include the homogeneity and proper intensity of the cooling system.

The internal foil hose cooling process has been managed to be considerably improved (as cited above our patent specification) compared to the former state of the art. However, in the course of our latest experiments performed on our prototype of the apparatus, we also gained further recognitions, to be detailed below.

One of our recognitions is that if a coolant flow is generated by tangential nozzles near the foil, fed by compressed coolant, e.g. air, then the stability of the blown-up foil hose to be cooled began to decrease by increasing the quantity of cooling air over a certain limit value. Surprisingly, similar phenomena were detected when applying compressed air of reduced pressure.

Furthermore, it has been recognized that by applying an internal space filling inlet unit (internal conical and/or cylindrical cooling device) within the blown foil hose, thereby generating a ring-shaped flow space of relatively smaller cross-section between the inlet unit and the foil, then the medium flow will move along a previously determined track within this ring space, that is, in the gap. So a thinner “boundary air layer” is generated on the surface of the foil, without any stagnant airflows in the ring space.

We also recognized that the loss of stability of the foil hose (as mentioned above) could be traced back to the stagnant air quantities and the uncertain motion track of the cooling medium flow. As regards our earlier internal foil cooler devices, although air nozzles were placed inside, the large size of the internal space of the foil hose resulted in the fact that the cooling air flowing out of the nozzles could move away from the immediate surface of the foil quite soon, therefore a thicker boundary air layer could be generated along the surface of the foil. Furthermore, a considerable part of the cooling air stagnated and whirled in the internal space.

On the contrary, in accordance with the present invention, if a considerable part of the internal space of the foil hose is filled out, by the inlet body (e.g. by a conical funnel and a related cylindrical inlet element), then the cooling air blown in will move along a prescribed track, generating a minimum boundary air layer, with no stagnant and whirling air flows possible to be generated.

By applying such additional internal inlet profile connected to a cylindrical inlet component arranged in the initial part of the cylindrical section of the blown foil hose, e.g. a funnel or a cone, the intensity of internal cooling can be considerably increased. However, according to our experiments the size of the gap formed between the foil hose and the inlet cone cannot be controlled because if the air blown in flows at a specified speed, a gap of adequate size is formed to ensure air removal.

It has also been recognized that in order to form a relatively small-sized constant gap at various airflows, it is expedient to controllably increase air speed along the cylindrical section following the inlet cone of the foil hose. Thereby a constant gap size can be formed even in the case of changing coolant quantities or speeds. Thus, the final size of the blown-up foil hose can be surprisingly accurately calibrated in accordance with the diameter of the cylindrical section.

So, on the basis of our perception last mentioned, heat transfer of practically any intensity (e.g. tempering, mainly cooling) can be generated in accordance with the present invention. Besides, the foil hose is blown up stably and exactly to a prescribed diameter, meaning that the proposed cooling system can be applied at the same time as a ‘foil hose calibre’.

The proper control of the size of the annular gap is surprisingly achieved—according to the present invention—by suddenly increasing the speed of the cooling air-flow. In the event of cooling with a small amount of cooling air, a small gap is formed automatically; however, by increasing the quantity of air, the size of the gap will also increase. But, if the speed of the cooling air is increased in the annular gap, the size of the gap will inevitably be decreased because being speeded up; the given quantity of air can get away through a smaller gap as well.

According to our further perception, the speed of the medium flow for heat transfer can be increased by reducing the braking effect of the boundary air layer, or even by transforming braking into acceleration. If e.g. cooling air flows are in the gap as heat-transferring medium, a so-called ‘boundary air layer’ will surely be formed along the delimiting mantle in a known manner, where the air layer is actually “standing”; and this boundary air layer will inevitably exert a braking effect on the layer of flowing air adjacent to it. On the other hand, if—according to our perception—this boundary air layer was also put into motion, the braking effect above would also be decreased, or eliminated. Moreover, the medium flow may be made to have an accelerating effect by applying greater speeds.

As the “boundary layer” of the heat-transferring medium, e.g. air, is always at a standstill close to the delimiting wall, so its speed is identical with the speed of the wall, we think that the ‘boundary layer’ can only be moved together with the delimiting wall. But, if the de-limiting wall is moved at an identical speed with that of the flowing air, the braking effect of the boundary layer will theoretically be already eliminated. If the speed of the delimiting wall is greater than the speed of the flowing air, the surrounding air layers can even be accelerated by way of the boundary layer.

According to our experiment results, the intensity of the heat transfer can considerably be improved by increasing the speed of the heat-transferring medium flow. However, taking our latter perceptions into consideration, another original opportunity is presented, e.g. for cooling extruded products, particularly plastic foils. According to the present invention, the heat is transferred from the foil to the medium flow, e.g. to cooling air flow moving in the gap; from the air it is transferred to the rotating mantle; from the rotating mantle to the stator; and from the stator it is removed to the environment e.g. by water or air.

Our experiments have shown that in such a system, the quantity of the air-flow blown in does not substantially affect cooling process because the heat exchange here is achieved nearly completely by heat transfer, rather than by heat conveyance. Consequently, the intensity of heat transfer is not fundamentally affected by the quantity of the exhaust cooling air, but actually by the speed status of the air between the foil hose and the rotating delimiting mantle, that is, the relative speed difference and the temperature difference between them.

As the plastic foil hose is drawn at a given speed, the speed of the wall constituted by the foil cannot be influenced. On the other hand, the wall of the internal or external cylindrical mantle can be moved—preferable rotated—at any discretionary speed. Therefore, by changing the “r.p.m.” of the cylindrical mantle, the peripheral speed of the mantle surface and thereby the size of the gap, can precisely be controlled.

In order to be able to increase radial and tangential components of the coolant speed, grooves and ribs of small depth and width can be formed on the surface of the rotating mantle, at an angle to the axis, in accordance with the invention. Thereby the rotating mantle surface theoretically operates as a “fan wheel”, meaning that it sucks the space below it, accelerates the air suck in within the gap, and forwards it to the space over it.

Air/pneumatic radial bearings can be applied for embedding the rotor shaft, whose air can also act as secondary cooling medium in the system. However, any other known bearings can be used.

The rotor can be rotated e.g. by air nozzles of compressed air or a constrained rotary drive, or by combination thereof. Air bearings can also be used for the axial bearing of the rotor. Rotation can be generated e.g. by friction drive, where the driving friction wheel itself can be used as radial support for the rotor. The rotary friction drive of the rotor may have one or more friction wheel(s) being in frictional driving connection with the rotor.

The housing of the apparatus can be provided with inlet chambers in its sections being adjacent to the rotor for the pneumatic bearing of the rotor, and each inlet chamber is to be connected to its own compressed air source having individual control.

The delimiting mantle—serving as “heat-receiving surface”, or in other embodiments as “heat-discharging surface”—is preferably formed on the mantle surface and/or on the head surface of the rotor.

The heat-transferring apparatus according to the invention can be formed as improved drying device/tunnel for the material layer, preferably printed thermoplastic foil, comprising at least one tempering cylinder, which is rotatable arranged in the housing (as rotor) along a track of freshly printed foil. The delimiting mantle of the rotor/tempering cylinder is arranged with the predetermined gap, receiving the heat-transferring medium flow, from the material layer, preferably from the printed side of the foil. Along a track of foil, the tempering cylinder/the rotor is preceded and succeeded by at least one guide roller.

Preferably the apparatus is provided with at least two tempering cylinders, each of them is associated with two of said guide rollers. At least one of the tempering cylinders can be used as paint drying device, and at least one other tempering cylinder can be used as foil re-cooling device.

The one side of the material layer, preferably foil to be tempered is associate with at least one of said tempering cylinder designed as said rotor, and an additional—preferably cool-able and/or heat-able—tempering unit is provided on the opposite side of the material layer, which is also arranged at a predetermined interval corresponding to a gap from the foil F, receiving another heat-transferring medium flow.

In a preferred embodiment of the invention, at least one of the rotors, tempering cylinders and/or the guide rollers has a mantle surface designed like a barrel, or provided with two symmetric truncated cones, whose diameter is decreasing outwards.

It is to be noted that in the case of certain applications, the delimiting mantle can perform other types of relative motion—besides rotation—as compared to the material layer, e.g. the foil hose involved in the heat transfer, such as linear alternating or curved alternating motion, elliptical motion, wobbling motion, etc. or any combination thereof.

Based on the above principles and features of the present invention, the following two systems have been established as examples. As for the first system, the axial and tangential speed components of the turbulent cooling medium flow are both increased, but in the case of the second example, only the tangential component is increased. Thereby in the first case the heat of the foil is removed mostly by the cooling air-flow, whereas in the second case the heat is removed by heat transfer through the internal device placed in the foil hose, by using the cooling air flow.

### BRIEF DESCRIPTION OF THE DRAWINGS

The invention is disclosed in more detail on the basis of the accompanying drawings showing a few embodiments of the solution according to the invention. In the drawings:

FIG. 1 contains details A), B) and C) illustrating the speed relations of the prior art and the present invention, respectively;

FIG. 2 illustrates a half cross-section of the first embodiment of the apparatus according to the invention;

FIG. 3 shows a top view of the whole apparatus in FIG. 2, in relatively reduced scale (without foil hose and casing);

FIG. 4 illustrates a view in direction of arrow X in FIG. 2 (without foil hose);

FIG. 5 shows a simplified half cross-section of the second embodiment of the apparatus according to the invention;

FIG. 6 is a cross-section along line VI-VI in FIG. 5, in relatively larger scale;

FIG. 7 shows a half cross-section of the third embodiment of the apparatus according to the invention;

FIG. 8 is a simplified illustration of the fourth embodiment of the apparatus according to the invention;

FIG. 9 is a side view of the fifth embodiment of the apparatus according to the invention;

FIG. 10 illustrates a vertical arrangement of the solution shown in FIG. 9;

FIG. 11 shows a version of the apparatus of FIG. 10;

FIG. 12 is a simplified view of the sixth embodiment of the apparatus according to the invention;

FIG. 13 illustrates a completed embodiment of the apparatus of FIG. 12;

FIG. 14 shows a version of the detail of FIG. 13, in relatively larger scale;

FIG. 15 comprises details A, B and C showing a foil guide roller of the apparatus of FIG. 13, in different views;

FIG. 16 illustrates a further embodiment of the apparatus according to the invention;

FIGS. 17 and 18 show side view and top view, respectively, of a further embodiment of the apparatus according to the invention;

FIG. 19 shows a side view of an other embodiment of the apparatus according to the invention;

FIG. 20 is cross-section along line XX-XX in FIG. 19;

FIGS. 21 and 22 illustrate two further special embodiments;

FIGS. 23 and 24 illustrate an other embodiment of the apparatus according to the invention, wherein FIG. 23 is a side view and FIG. 24 is a cross-section along line XXIV-XXIV in FIG. 23;

FIG. 25 shows a version of the apparatus of FIG. 23;

FIGS. 26 and 27 is a side view and top view, respectively, of a further special embodiment;

FIG. 28 is a simplified view of the last illustrated embodiment of the heat transferring apparatus according to the invention.

### DETAILED DESCRIPTION OF ILLUSTRATED EMBODIMENTS

To avoid any doubt, it is to be noted in advance that the term of “tempering” by heat transfer is used in the broadest sense possible, both in the description and claims, so it should be interpreted as cooling at some instances, as keeping at the same heat or as heating at other instances.

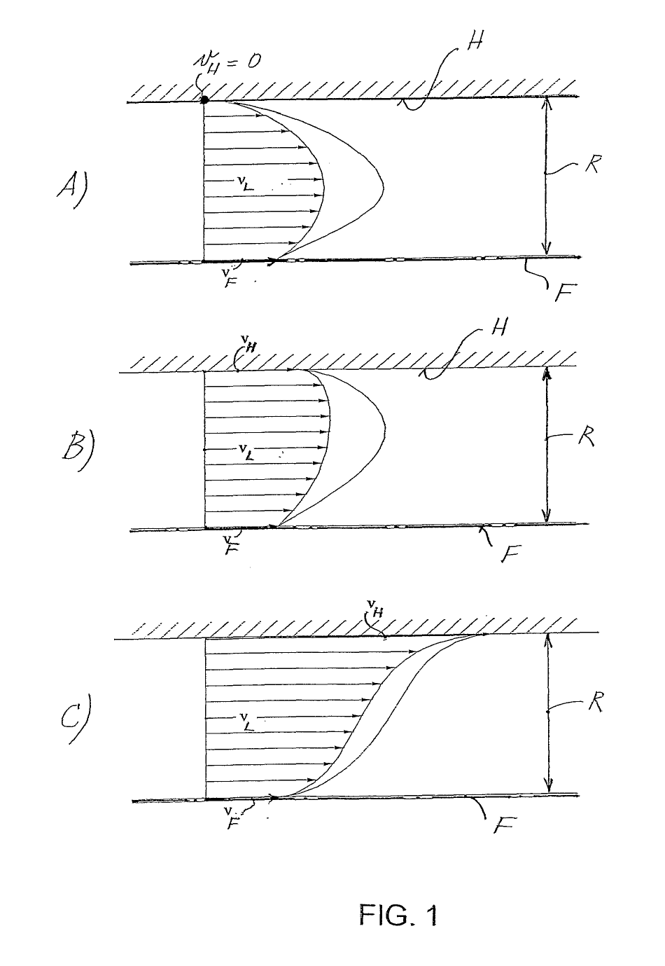

Section A) of FIG. 1 illustrates the speed relations of extruded foil-cooling in order to present the traditional technology of heat transfer, where one of the participants of heat transfer is a plastic material layer, a foil hose F itself to be cooled (it is a “heat-discharging surface”), which is moved (drawn) at a foil speed v_{F} of e.g. 150 m/min. A delimiting mantle H (this is a “heat-receiving surface” of a solid body participating in heat transfer) located at an interval or a gap R of 2 to 5 mm from the foil hose F, is arranged in a stationary fashion, meaning that its mantle speed v_{H} is zero. In the cross-section of the gap R, arrows of various sizes indicate a speed v_{L} of the cooling air acting as heat transferring medium flow, the mean/average value of which is 170 m/min in the present case.

By using this traditional heat transfer method the wall thickness of the foil hose F was 7 μm, but there were inequalities of thickness at some places in the product, as a result our experiments.

Section B) of FIG. 1 already illustrates the heat transfer according to the invention. Here, a substantial difference lies in the fact that the heat-receiving surface of the delimiting mantle H as solid body is not stationary, but it is rotated in order to reduce or eliminate the braking effect of a “boundary layer” of the cooling air, in a direction transversal to the vector of a speed v_{L} of the medium flow for heat transfer. In the present case, the peripheral speed v_{H} of the delimiting mantle H is selected to be 160 m/min (this speed vector is rotated into the surface plane for the sake of illustration and comparability). The value of the foil speed v_{F} is selected to be 150 m/min here as well, and the average value of the speed v_{L} of the cooling medium flow to be 170 m/min.

According to our experiment results, considerable positive changes occurred even with these figures; in operation the size of the gap R was reduced and stabilized at the value of 2 mm, and the foil hose F was is 7 μm thick here as well, but its quality was much more even than in the traditional solution.

Section C) of FIG. 1 shows an even more favourable version of the heat transfer system according to the invention, where the only difference compared to section B) is that here the peripheral speed v_{H} of the heat-receiving surface of the delimiting mantle H is selected to be 1500 m/min (this speed vector is also rotated into the surface plane).

By increasing the speed v_{H} of the delimiting mantle H to such a significant degree, it has been surprisingly achieved that as a result, the average value of the speed v_{L} of the medium flow suddenly increased from the original 170 m/min to approx. 700 m/min, meaning that the turbulent medium flow for heat transfer is considerably accelerated. As a result, during operation the stable size of the gap R is further reduced to approx. 0.5 mm. The wall thickness of foil hose F was 7 μm, but it is was absolutely even (that is constant).

As the foil hose F is drawn at a given speed v_{F} in the course of cooling after extrusion, so the speed v_{F} of the foil hose F cannot be influenced. On the other hand, the heat-receiving surface of the delimiting mantle H can be moved—rotated in the present case—at a discretionary peripheral speed v_{H} according to the invention in order to eliminate the braking effect of the boundary air layer as well as to effectively accelerate the air flow and keep it in a turbulent condition. Our experiments obviously demonstrated that the speed v_{H} of the delimiting mantle H can be controlled by changing the r.p.m. of the cylindrical delimiting mantle H, and thereby surprisingly the size of the gap R can be precisely adjusted.

In order to be able to increase both the axial and tangential vector components of the speed v_{L} of the medium flow, grooves and dents of e.g. of small depth and width are formed on the surface of the relatively rotating delimiting mantle H, which are preferably at an angle with the rotation axis of the rotor comprising the delimiting mantle H (these are to be presented below in relation with FIG. 4). Thereby the rotating delimiting mantle H and the rotor theoretically operate similarly to a “fan wheel”, meaning that it sucks the annular space—that is, the gap R—below it, accelerates the air suck in within the gap R, and forwards air upwards.

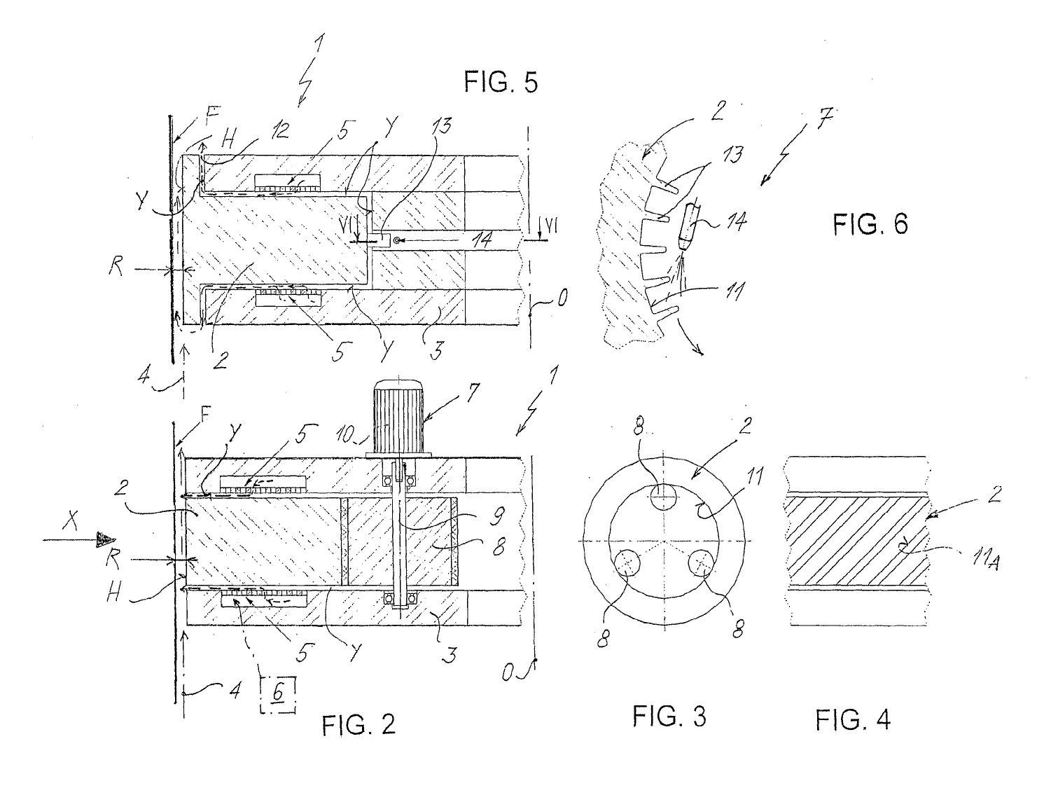

FIG. 2 shows the outline of a first embodiment of an apparatus 1 for heat transfer—for foil tempering in the present case—, designated for cooling an extruded blown packaging foil hose F. This apparatus 1 is mounted on a known extruder head (not illustrated separately) in a concentric manner to a drawing opening to shape the foil hose F from thermoplastic synthetic material as known. A common theoretical median line (axis) of the foil hose F and the apparatus 1 is designated by “O”.

FIG. 2 only shows an outline of the initial part of the cylindrical section of the cooling and stabilization part of the blown-up foil hose F in which a disc-like rotor 2 of the inner foil cooling apparatus 1 according to the invention is arranged in a concentric manner, and the rotor 2 is embedded in a cylindrical housing 3 of the apparatus 1 in a rotatable manner. The housing 3 is fixed in the inner space of the foil hose F (the manner of fixation is not illustrated separately).

According to the invention, a speed v_{L} of a heat-transferring medium flow 4—a cooling air flow in the present case—can be controlled according to the invention by changing a peripheral speed v_{H} of the cylindrical delimiting mantle H and the r.p.m. of the rotor 2, and at the same time thereby the size of the stabilized gap R can also be controlled.

As shown in FIG. 2, the external delimiting mantle H of the rotor 2 (it is in the present case “the heat-receiving surface” of the solid object during the heat transfer) is located at a radial interval—corresponding to the predetermined gap R—from the internal wall surface of the foil hose F (it is the “heat-discharging surface” of the material layer), which interval, that is, gap R during operation is stably of 0.5 mm as mentioned in the description of section C) of FIG. 1. The gap R forms a circular annular space along the inner surface of the blown foil hose F for the turbulent medium flow 4 progressing spirally upwards, indicated by arrows.

In the arrangement according to FIG. 2, air (pneumatic) bearing has been applied for embedding the rotor 2 in the housing 3. In other words, this means that the rotor 2 is arranged in the housing 3 allowing for slight axial displacement, and a multitude of slots Y produced this way are connected to a heat-transferring medium source 6 (e.g. compressor or pressurized air tank) through a multitude of blow-in or inlet chambers 5 shaped in the housing 3.

Thus, the pressurized air pressed from the blow-in chambers 5 to the slots Y embeds the rotating rotor 2 as an air cushion, and at the same time this air acts as a secondary heat-transferring medium, meaning that in the present case it also serves as a coolant because, in accordance with the indented arrows, it effectively cools the rotor 2 and the housing 3, both heated up through heat transfer, on the one hand. On the other hand, as it gets into the gap R, it is added to the above mentioned medium flow 4 for primary heat transfer, improving the heat transfer effect. Let us note, however, that any other known bearings can be applied for the rotor 2, and the cooling of the rotor 2 can be achieved in another known manner as well besides the internal air cooling mentioned above.

In the embodiment according to FIG. 2, the rotor 2 is equipped with a rotary drive 7 of constrained drive. Here, a friction drive is applied as the rotary drive 7, whose at lease one friction wheel 8 receives rotary drive through a shaft 9 from a driving motor 10, which can be e.g. an electrical motor, with controllable r.p.m. (“r.p.m.” means: “revolution per minute”). A radial support for the rotor 2 is provided in this embodiment by the driving friction wheel 8, itself.

FIG. 3 shows a reduced top view of the apparatus 1 of FIG. 2, illustrating that in this case at least one of the three friction wheels 8 of the friction rotary drive 7 is in a frictional driving connection with an internal mantle surface 11 of the annular rotor 2. The friction wheels 8 are located at 120° from each other along the perimeter of the mantle surface 11.

By rotating the rotor 2, the tangential and axial speed components of the medium flow 4 are increased, according to the invention, to the previously specified degree. For this effect the delimiting mantle H of the rotated rotor 2 preferably has inclined ribs or extensions and/or a grooves 11 or dents, or perforations, or any other formation or fixture (see FIG. 4), which are suitable for further increasing the tangential and/or axial speed component(s), and thereby the turbulence of the heat-transferring medium flow 4.

In the course of operation, the pressurized medium flow 4 going spirally upwards in the gap R is gradually heated up by removing the heat of the foil hose F; then, according to the invention, the heat of the medium flow 4 is taken over by the delimiting mantle H of the rotor 2. Eventually, most of this heat gets into the housing 3 embedding the rotor 2, mostly through heat transfer. From here the heat is removed in a manner known in itself, e.g. by cooled air or water, and emitted to the environment (not illustrated separately).

In the course of our tests, the r.p.m. of the rotor 2 was selected so that the peripheral speed v_{H} of the delimiting mantle H should be 1500 m/min (see section C, in FIG. 1). Let us mention that even if the r.p.m. of the rotor 2 is considerably decreased, but the heat removal—as mentioned above—is maintained, the system will still operate in an acceptable manner.

The second embodiment according to FIGS. 5 and 6 differs in only three aspects from the first embodiment according to FIGS. 2 to 4. One of the differences here is that a rotor 2 of the heat-transferring apparatus 1 is provided with a delimiting mantle H of increased axial size at its mantle, therefore outlets 12 of the slots Y of air bearings do not lead directly into the gap R of the main cooling medium flow 4, but they are located farther by a radial interval.

The second difference is that the radial embedding of the rotor 2 is also achieved by compressed air through inlet chambers 5 and vertical slots Y.

The third difference is that here the rotary drive 7 of the rotor 2 is also provided by compressed air, that is the rotary drive 7 is practically a pneumatic drive. For this purpose, an inner mantle surface 11 of the rotor 2 is equipped with a multitude of blade-like ribs 13 or grooves. These are arranged at identical intervals from each other along the perimeter, and they cooperate with at least one nozzle 14 to feed in compressed air (FIG. 6). The nozzle 14 is connected to a controllable compressed air source, whose pressure can be e.g. 4 bars (no illustrated).

It also applies to both embodiments according to FIGS. 2 and 5 that two or more of the rotors 2 can be arranged coaxially in case of relatively high peripheral speeds, in a consecutive arrangement looking into the axial direction. In a given case, the consecutive rotors 2 can be rotated in relatively opposite directions thereby the stability of the foil hose F can be further increased.

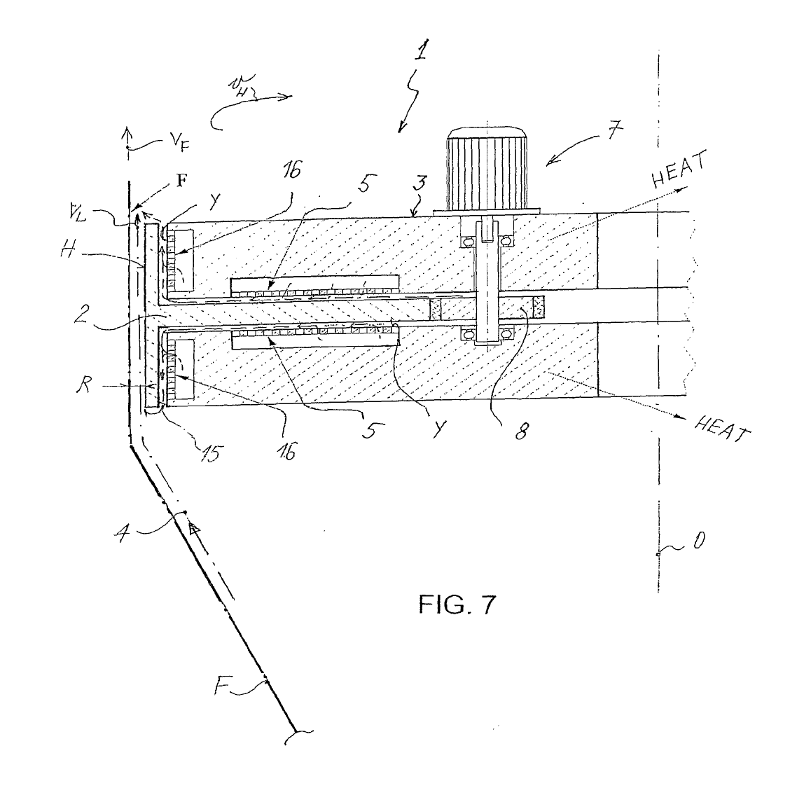

The embodiment according to FIG. 7 is essentially a combination of the solutions according to FIGS. 2 and 5. Here a rotor 2 of a foil cooling apparatus 1 is provided with a rotary drive 7 and pneumatic axial bearing as above, and a radial support through a friction wheel 8 of a rotary drive 7. The shape of the rotor 2—having a delimiting mantle H—differs from the one according to FIG. 5 in that here its internal disk-like part of the rotor 2 is relatively flatter.

Another difference is that here an outer mantle 15 of the housing 3 is equipped with a number of additional blow-in or inlet chambers 16, which are connected to a compressed air source (not illustrated), fully independent from that of the blow-in chambers 5, and said inlet chambers 16 are arranged in identical intervals along the perimeter.

By separately controlling the air inlets of the blow-in/inlet chambers 5 and 16, selective control can be provided for the radial pneumatic bearing of the rotor 2, on the one hand, and for the air cooling performed with a secondary heat transfer medium (airflow of pneumatic bearing), which cools mainly the housing 3 and the rotor 2.

For each of the embodiments above, the peripheral speed v_{H} of the delimiting mantle H (having here the function of a heat-receiving surface) of the rotor 2 was selected to be 1500 m/min, and the original feed-in speed of the medium flow 4 in the gap R to be 170 m/min, which was then accelerated to a turbulent medium flow 4 of 700 m/min by applying the rotation of the rotor 2. In accordance with section C) of FIG. 1, the draw-down speed v_{F} of the foil hose F was 150 m/min; the stable size of the gap R was 0.5 mm, and the wall thickness of the foil was 7 μm, but totally even.

Let us mention, that any of the systems above ensuring internal cooling of the foil hose F can be easily adapted for the external cooling of the foil hose F by a skilled person, on the basis of the disclosure of the invention. Only a ring-like rotor should be arranged along the external surface of the foil hose F by interposing an external gap R. Thus, the apparatus for tempering, e.g. for internal and/or external foil cooling can be realized in various versions in accordance with current users' needs, and in accordance with the invention as disclosed.

The foil cooling apparatus 1 of an internal inlet type can be combined in a given case, e.g. with at least one conical leading mantle arranged at a prescribed interval from the conical section of the blown-up foil hose F preceding its cylindrical section (not illustrated separately).

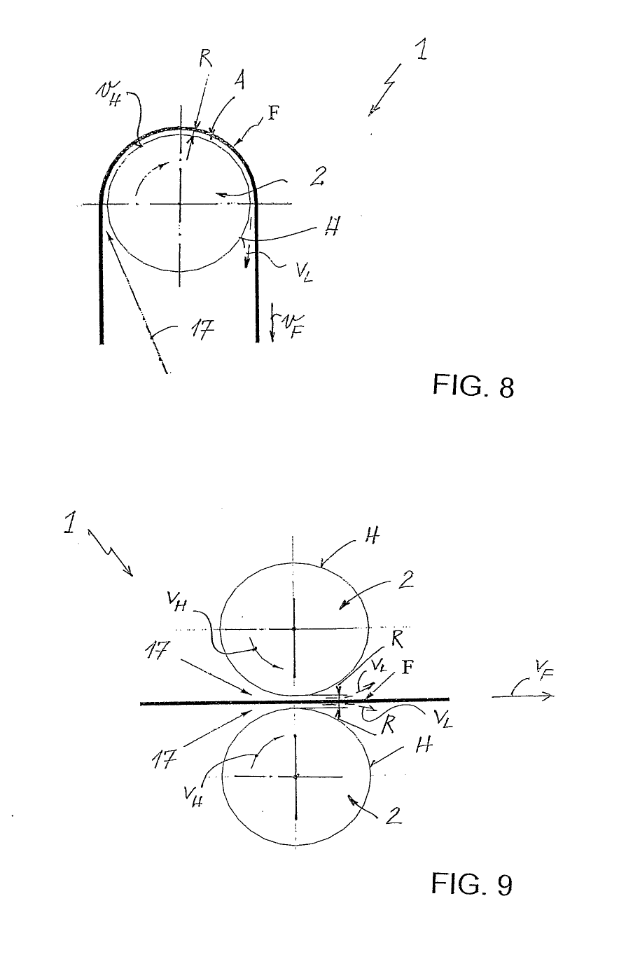

Besides foil hoses, the invention can also be applied for the cooling of any other band-type products, such as extruded plain plastic foils, with similar advantages. Some examples are outlined in relation with FIGS. 8 to 11. (We note that in the specification, the terms ‘foil’ and ‘foil hose’ are both designated by the same reference character ‘F’.)

According to FIG. 8, a further embodiment of the rotor 2 of a foil cooling apparatus 1 according to the invention is formed as a rotated cylindrical drum comprising a cylindrical delimiting mantle H (heat-receiving surface) of which a plain foil F to be cooled is flung over with the interposition of a thin gap R (and a heat-transferring medium flow 4 therein). The draw-down speed v_{F} of the foil F, the peripheral speed v_{H} of the delimiting mantle H of the rotor 2, and the size of the gap R can be identical with the values specified in Section C) of FIG. 1.

An internal cooling of the drum-like rotor 2, heated up through the heat transfer, can be achieved in a manner known in itself (not illustrated). It results from the considerable difference between the peripheral speed v_{H} of the delimiting mantle H of the rotor 2 and the progress speed v_{F} of the foil F that the rotor 2 ‘takes’ always a thin layer of air into the gap R, which is indicated by an arrow 17.

By way of this arrangement, the foil F can be efficiently cooled and smoothed out in the meantime, which is also an important step before rolling up. Through the relatively thin layer of turbulent air-flow 4 in the gap R, the heat of the foil F can be effectively transferred to the rotor 2 and it can be easily removed there-from. (A housing embedding the rotor 2 is not illustrated separately.)

The embodiment according to FIG. 9 differs from the arrangement according to FIG. 8 in that here a heat-transferring apparatus 1 has a drum-like rotor 2 on both sides of the foil F, thus an air intake (see arrow 17) is provided on both sides into the gaps R. The thin air layers acting as additional medium flow in the gaps R, not only perform a heat transfer, but foil smoothing effect as well, what is an additional advantage.

In a given case, more than one rotor pairs can be applied consecutively. The axles of the rotors 2 can be parallel by pair, but in a given case, they can be at another angle with each other. The size of the gap R and the values of the speeds (v_{F}, v_{L} and v_{H}) can be identical with the values specified in Section C) of FIG. 1.

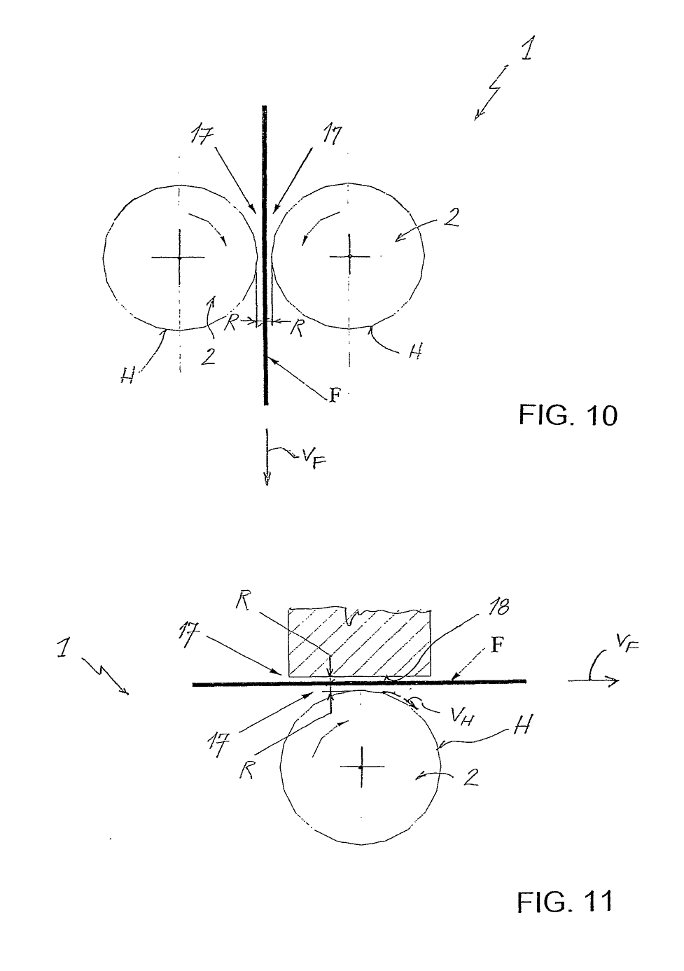

The next arrangement (in FIG. 10) is a version of the heat-transferring (foil cooling) apparatus 1 according to FIG. 9, where the single difference is that the foil F is in a vertical position.

The arrangement in FIG. 11 is a version of the apparatus 1 according to FIG. 9, where the upper rotor is substituted by a fixed plain support element 18. A certain degree of air intake designated by arrow 17 can be expected at an upper gap R as well, which is also due to the relative speed v_{F} of the foil F. The speed v_{H} of the delimiting surface H of the rotor 2 located at a gap R beneath the foil F and its effects are identical with that of the embodiments above.

For the embodiments according to FIGS. 9 to 11, the air intakes (see arrows 17) as mentioned result in the fact that due to this air layers in the thin gaps R—the so-called ‘boundary layers’—the cooled band-type product, like foil F does not contact directly with the delimiting mantle H. On the other hand, these boundary air layers not only cool the product, but smooth it and even forward it in a given case. These latter additional effects can be properly utilized, e.g. in case of the parallel guidance and joint cooling of several extruded threads, where the threads, still in a plastic state, cannot directly contact with the delimiting mantle, only through the air gap R.

For cooling of plane band-type products, a further version of the apparatus is also possible, where the rotor—performing rotary or tottering motion—is shaped as a plane disc and the stationary or moved band to be cooled is arranged with gap-size intervals from its upper or lower front (to be detailed below).

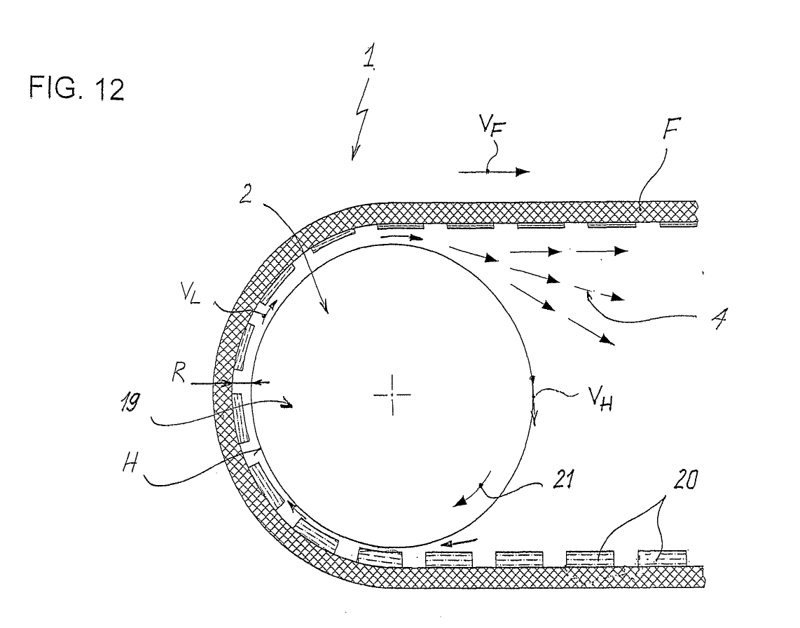

Another application field of the heat transfer technology according to the invention can be the drying of plastic band-type products (e.g. paper industry products) or freshly printed band-type products. A second group can include the drying of extruded and cooled foils F after being printed in a known manner; for this purpose, a tempering apparatus is proposed which comprises e.g. a tempering cylinder rotating at a high speed as a rotor. FIG. 12 provides an example of the theory of operation thereof; it can be suitable for replacing the traditional drying tunnel of foil printing machines.

According to FIG. 12, a tempering cylinder 19 is applied as a rotor 2 of a foil drying apparatus 1 for implementing the heat transfer technology according to the invention. The cylinder 19 is rotated at a high speed v_{H}, across whose delimiting mantle H (as heat-discharging surface), the freshly printed plane foil F is flung over in a span angle of approx. 180° in the present case, with its printed surface towards the delimiting mantle H of the rotor 2. In FIG. 12, a multitude of paint traces (illustrated by small rectangles) form a paint layer designated by 20).

The delimiting mantle H of the rotor 2 can be e.g. smooth as glass (or uneven or patterned in its surface). According to our experiments, this rotating delimiting mantle H always generates a thin layer of air (boundary layer) in the gap R between the foil F and the delimiting mantle H, therefore the still soft paint layer 20 (which, in the present case, is a material layer containing plastic and/or fluid material which participates in heat transfer, and the foil F is actually a carrier layer only) can never contact with the delimiting mantle H of the cylinder 19, therefore the paint is not blurred. The paint layer 20—as material layer containing plastic and/or fluid material—as one of the participants in heat transfer (as heat-receiving surface) may be continuous and/or intermittent.

In the gap R, due to the relative speed difference between the delimiting mantle H of the rotating cylinder 19 and the moved foil F (Δv=v_{H}−v_{F}), the layer of air in the gap R is set in turbulent motion, meaning that the turbulent medium flow 4 for heat transfer is generated, which has an extremely intensive heat transfer impact, mainly justified by the speed dependence of the heat transfer coefficient as discussed above. From the above, it can be concluded that there is of course a mixing of radial nature as well within the turbulent medium flow 4 in the gap R.

Therefore, the delimiting mantle H of the rotating cylinder 19 has a tempering effect, meaning that it can be used for heating (as heat-discharging surface) and for cooling (as heat-receiving surface); its heating or cooling unit can be a device known in itself.

As a result of intensive heat transfer and the hot air flowing at a high speed v_{L} in the gap R (FIG. 12), the heat is taken precisely to the painted internal surface of the foil F, and from there the solvent of the paint—intensively evaporating to the impact of the heat—is also removed by the medium flow 4 (by the drying air flow), which constitutes an additional impact.

On FIG. 12, the direction of rotation of the tempering cylinder 19 is indicated by an arrow 21, the progress speed of the foil F by v_{F}, the speed of the tempering air flow acting as heat-transferring medium flow for by v_{L}, and the speed of the delimiting mantle H by v_{H}. A known—preferably controllable—rotary drive of the cylinder 19, its heating/cooling unit, and its shaft embedding are not specifically detailed.

In the course of our tests, the peripheral speed v_{H} of the delimiting mantle H was 1100 m/min; the draw-down speed v_{F} of the foil F was 350 m/min; the size of the gap R was 0.1 mm; and the controlled drying temperature of the tempering cylinder 19 was 80° C.

With a view to the fact that the speeds v_{F} and v_{H} have the same direction in the arrangement according to FIG. 12, the resulting speed v_{L} of the tempering turbulent air flow 4 in the gap R was the arithmetic average of the former two values, that is, approx. 700 m/min.

Our experimental results show that using the tempering system according to FIG. 12, the above mentioned disadvantages of the traditional drying tunnels were fully eliminated, which is due to the fact that:
The heat-transferring medium flow 4, e.g. a drying air flow, only flows in the relatively narrow gap R, thus a considerably greater air exchange can be achieved by an air flow of a volume which is smaller by several orders of magnitude, as a result of the great relative speed difference;
The rotating tempering cylinder 19 needs to heat (or cool in a given case) only the relatively small quantity of air flowing in the gap R, therefore the energy demand is much lower, than at the traditional drying tunnels;
The temperature of the medium flow 4 for heat transfer can be freely increased as only the paint layer and not more than the surface layer of the foil are heated up during the short time of the tempering step, thus, we need not be afraid that the entire foil F gets softened, which is to be avoided anyway;
In this solution, the tempering cylinder 19 properly guides the foil F through the gap R, so it cannot “swing”, therefore the speed of the foil track can be increased, which results in a considerable additional impact for the manufacturers.

As mentioned above, in the present case (FIG. 12) the tempering cylinder 19 rotates in clockwise direction, but in a given case it can also rotate in the opposite direction. With the cylinder 19, rotating at a peripheral speed v_{H}, which is in the opposite direction compared to the speed v_{F} of the foil F, heat transfer (e.g. drying) will become even more intensive because at such instances, the speeds v_{F} and v_{H} are aggregated, consequently the relative speed difference is increased. On the other hand, counter-flow drying can actually be realized by this way. In the course thereof, the solvent gets increasingly concentrated in the air flowing in the gap R, but due to the inverse speeds v_{F} and v_{H} the relative difference is constant, which ensures effective solvent removal on a continuous basis.

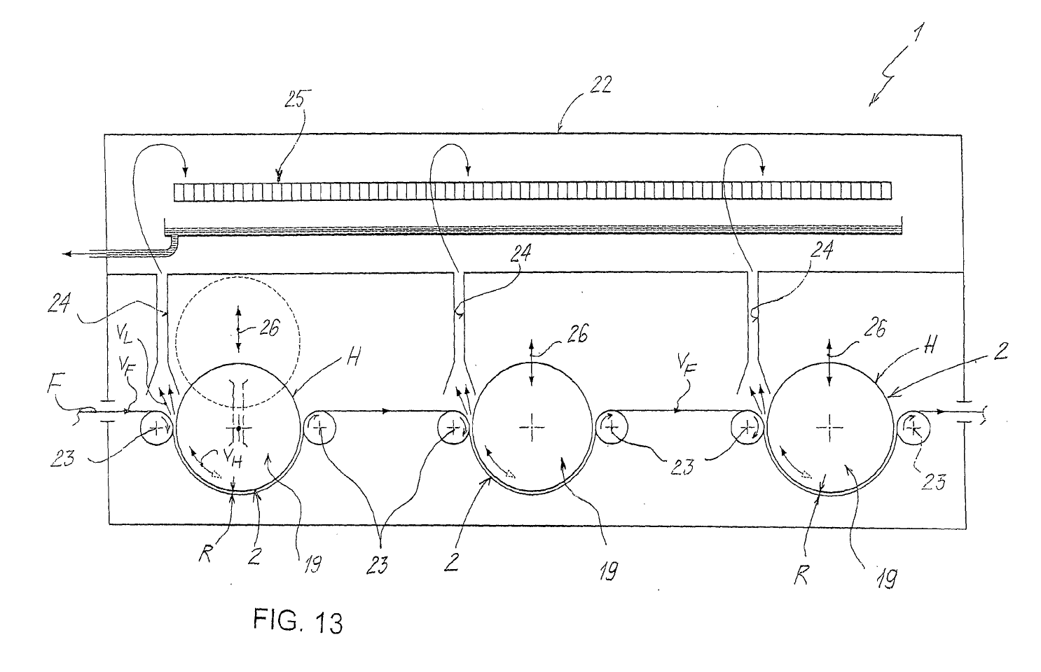

FIG. 13 shows a more detailed embodiment of the heat-transferring apparatus 1 according to the invention, which can be applied, e.g. drying tunnel for printed foils. In this arrangement, three tempering cylinders 19 are rotatable arranged as rotors 2 in a common housing 22 along a track of freshly painted/printed foil F in the known manner and moved at a speed v_{F}. In the present case, a delimiting mantle H of each rotor 2 rotates at a peripheral speed v_{H} opposite to the speed v_{F} of the foil F to be dried.

In the present case, along the track of the foil F, each of the rotated tempering cylinders 19 (as rotors 2) is preceded and succeeded by a guide roller 23 embedded in the housing 22 in a freely rotatable manner. Here, the guide rollers 23 are arranged in such a manner that they contact with an unpainted back-side of the foil F. The painted upper side of the freshly painted foil F is located around the mantle H of the rotating cylinders 19 as the rotors 2 in a span angle of nearly 180°, with the interpolation of a medium flow for heat transfer, flowing in the gap R at a speed v_{L}, substantially in the manner according to FIG. 12.

In FIG. 13, the housing 22 is provided on its upper part with at least one exhaust fan 24 for sucking the evaporated solvent from the area of each of the tempering cylinders 19, leading the exhaust air containing the solvent into a known condenser 25 (where the solvent precipitates and drips down, and then it is removed in a known manner). An additional advantage of this is that no air exchange needs to be performed in the apparatus 1, but the air containing solvent vapour cannot escape to the premises housing the apparatus 1, as it is circulated in a closed system.

In the present case, the rotating tempering cylinders 19 are embedded in the housing 22 in a displaceable manner according to an arrow 26, e.g. for an easier start-up or for adjusting the adequate span angle or drying surface. Therefore, the rotating tempering cylinders 19 can be elevated from the foil track in a given case. However, according to our experiments with this prototype, the tempering apparatus 1 can also be started in an operational state indicated in FIG. 13 by selecting a proper start-up order.

After drying the paint layer, the printed foil F must be cooled down to environmental temperature. However, in the case of tempering according to the invention, as mentioned above, only a thin surface layer of the foil F is heated up during the drying step, which can be cooled down relatively easily. The flexibility of the system according to the invention is further shown by the fact that the temperature of the tempering cylinders 19 (as the rotors 2) for drying or cooling can be freely adjusted.

In the arrangement of FIG. 13, the tempering cylinder 19 of the series of cylinders—looking into the direction of progress of the foil F—is switched over to foil cooling in the present case. Its operating temperature selected to be −5° C., in order to cool back the foil F provided with the already dried layer of paint to environment temperature (approx. 20 ° C.). The printed foil F, cooled down and finished, can then be rolled up and stored in a known manner.

The heat-transferring medium flow (e.g. air flow) circulating at a high speed v_{L} in the gap R to the impact of the third rotating tempering (cooling) cylinder 19 can cool back effectively the paint layer of the foil F and also its surface foil layer (which was during the drying step heated up). Consequently, for the embodiment according to FIG. 13, the last tempering cylinder 19 acting as a cooling device, together with its guide rollers 23, are associated with further two drying cylinders 19 acting as drying devices in the joint housing 22. Of course, in a given case, these can be arranged separately as well along the track of the foil F.

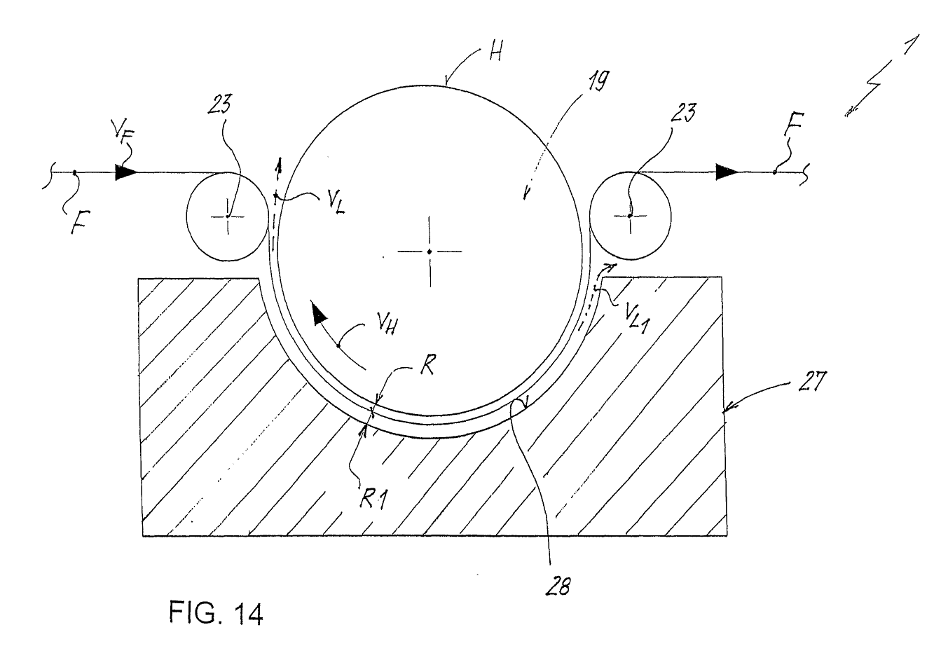

FIG. 14 shows a version of the tempering unit of FIG. 13, in relatively larger scale, which could be a simplified embodiment of the heat transfer apparatus 1 according to the invention being suitable for bilateral tempering. Here, our tempering technology has been further developed compared to the cylinder arrangement according to FIG. 13 in that an additional cool-able and/or heat-able tempering unit 27 is arranged on the lower side of the foil F to be tempered, which is provided with an arched nest 28 here, which latter is arranged at an interval corresponding to a gap R₁ from the foil F. The arrangement and mode of operation of the delimiting mantle H of the rotating tempering cylinder 19 and the associated guide rollers 23 substantially conform to what has been discussed in relation with FIG. 13, therefore this will not be touched upon again.

The paint on the foil F, freshly painted previously, can be dried effectively by the tempering medium flow (e.g. air flow) of a speed v_{L}, heated up between the delimiting mantle H of the tempering cylinder 19 rotated at a previously specified peripheral speed v_{H} and the foil F located at an air gap corresponding to the gap R there-from, and moved at a speed v_{F}, without the paint getting blurred due to direct contacts. Therefore, by selecting or changing the temperature of the rotating cylinder 19, the temperature and condition of only the paint layer and the surface layers of the carrier foil F are influenced according to the invention, if the drying operation is adequately rapid.

According to our practical experience, there may be cases when the foil acting as a carrier layer would be heated up a little bit more, but this is undesirable for the reasons mentioned above. It is mainly to prevent this safely that the technology according to the invention has been supplemented by the additional tempering unit 27 on the opposite side of the foil F, through the implementation of which the characteristics—temperature, softness, etc.—of the foil F can be influenced better and more accurately.

Thus, in the arrangement according to FIG. 14, the tempering unit 27 on the opposite side is formed as a fixed unit provided with an arched nest 28, and located to a gap R₁ from a lower surface of a semicircular section of the foil F, which is equipped with controllable heating and/or cooling (not illustrated). E.g. in case of higher drying intensity, the additional tempering unit 27 on the opposite side is set to cooling, thus the central and lower layers of the foil F can be constantly prevented from softening, thereby efficiency can be further increased.

Due to the other medium flow for heat transfer (e.g. air flow) of speed v_{L1}, generated in the lower gap R₁ between the foil F of speed v_{F} and the arched nest 28, the same phenomena are brought about as in the gap R between the foil F and the mantle H of the rotating cylinder 19. Here of course, the speed conditions are different as in the present case the tempering unit 27 on the opposite side is stationary. Let us note that in a given case, the tempering unit 27 on the opposite side can be supplemented by a rotor 2 as well.

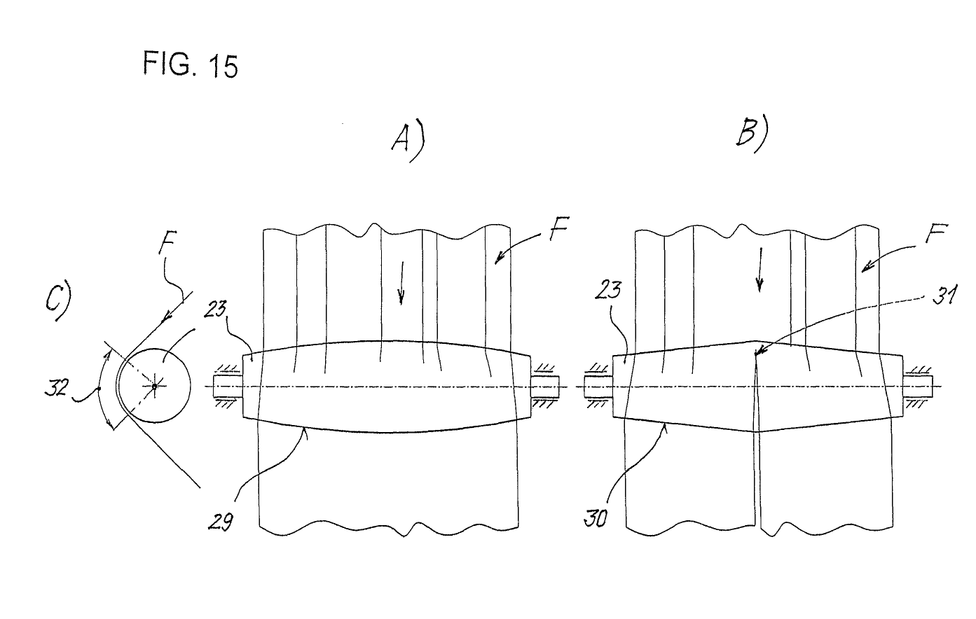

Two embodiments of the guide roller 23 are shown in sections A) and B) of FIG. 15 in an outline from above, then in a side view in section C). The main function of the guide roller 23 is to properly lead/guide the foil F. However, according to our invention, an important supplementary effect of the specially designed guide roller 23 can be to stretch, to de-crease the foil F, that is, to pull it apart and smooth it.

As already stated above, in the foil tempering apparatus 1 according to the invention, at least one rotating tempering cylinder 19, that is the rotor 2, is exclusively in indirect contact with the painted side of the foil F through a thin layer of air, driving and leading it at the same time. According to the present invention, the wrinkling or smoothness, tautness, more accurate running, track correction of the foil F, even the act of pulling it apart in case of it being split open can be influenced effectively by the guide rollers 23, namely by their shape, direction of rotation and/or their speed; however, the speed and tautness of the foil F must also be taken into consideration for this step.

A mantle surface 29 of the guide roller 23 shown in section A) of FIG. 15 is slightly curved like a barrel, but the guide roller 23 shown in section B) of FIG. 15 has a mantle surface 30 with two symmetric surfaces of truncated cone, whose diameter is decreasing outwards. By applying both embodiments, the foil F led in with creases will surely be smoothed out due to the lateral pull-apart effect of the mantle surfaces 29 and 30.

On the other hand, section B) illustrates a case where the track of the foil F has been split apart in the middle, at a location of a splitting point 31 (by a cutting tool, not illustrated separately). Due to the mantle surfaces 29 or 30, the foil F can be split into two foil sections when going through the guide roller 23, and then they can be rolled up separately.

Both effects can be achieved by both solutions according to FIG. 15 if the foil F is driven through the guide roller 23 in an adequate span angle 32 (see section C of FIG. 15). Therefore, the desired effects can be achieved effectively by changing the span angle 32, the degree of roundedness and conicity. If e.g. some guide rollers 23 of this design are applied in the foil drying apparatus 1, the foil F—dried and cooled back rapidly and efficiently—can be rolled up perfectly smoothly.

Of course, the proposed heat transfer technology can be used, besides tempering the plastic foil, for drying, keeping at a certain temperature, or cooling any other material layers, structural units, or products. E.g. in the case of printing, for a wide variety of carrier materials, such as paper, textile, plastic and aluminum foil, as well as combined multilayer raw materials.

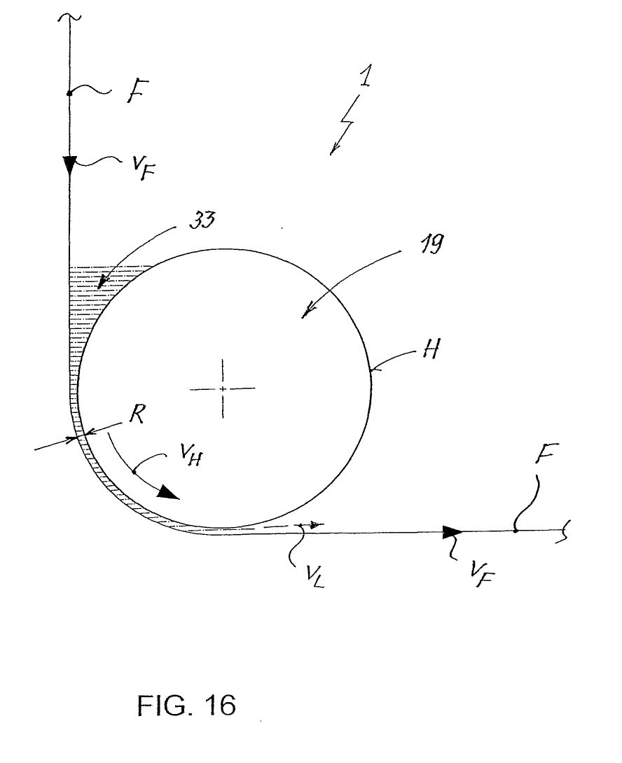

FIG. 16 shows a special embodiment of the heat-transferring apparatus 1 according to the invention, where a delimiting mantle H of a rotating tempering cylinder 19 acting as rotor, rotated at the speed v_{H}, is rotated in a fluid charge 33 (e.g. water) acting as a heat transfer medium. Accordingly, a medium flow (flowing boundary layer and/or fluid film) of the speed v_{L} is generated between the mantle H of the tempering cylinder 19 and the foil F from the fluid taken into the gap R between the foil F moved at the speed v_{F} and the mantle H of the tempering cylinder 19 due to the speed differences.

Here, as an example, the foil F is located at a span angle of about 90° around the tempering cylinder 19. Besides the advantages presented above, the heat conduction characteristics of the liquid, e.g. water, applied as tempering medium much better than those of air, are manifested as additional benefits.

In the embodiments above, the heat transfer, that is, cooling or drying effects of the turbulent medium flow in the narrow gap R—provoked by the cylinder mantle rotated at a high speed—were discussed. Naturally, the heat transfer according to the invention is not limited to the rotated cylindrical body or its cylindrical mantle. From the viewpoint of increasing the heat transfer coefficient, the main point is that the heat-discharging/heat-receiving surfaces should be located at a short distance from each other corresponding to the predetermined gap R, and that there should be a great speed difference between them.

This relative speed can be achieved not only by a cylindrical body, but by a body shaped as a polygon/prism; not only by a cylindrical mantle surface, but e.g. by a front surface; furthermore, not only by rotation, but by any of the surfaces of a body of discretionary shape, and by any type of motion, e.g. by straight-line or arched alternating, tottering motion, or any motions and combination thereof.

Obviously, the high-speed perpetuated (endless) motion can be generated by rotation in the simplest manner, but this can also be effected in several other ways, and it can be interpreted in several relations. As regards rotating bodies, not only their cylindrical mantle is rotated, but their front plates as well. E.g. in case of a plain cylindrical rotating body, that is, a disc, each point of the front plate performs rotary motion in the same way as the cylindrical mantle, but the peripheral speed of each point of the front plate changes linearly according to its radius. Naturally, this surface can also be used for heat transfer just as the cylindrical mantle.

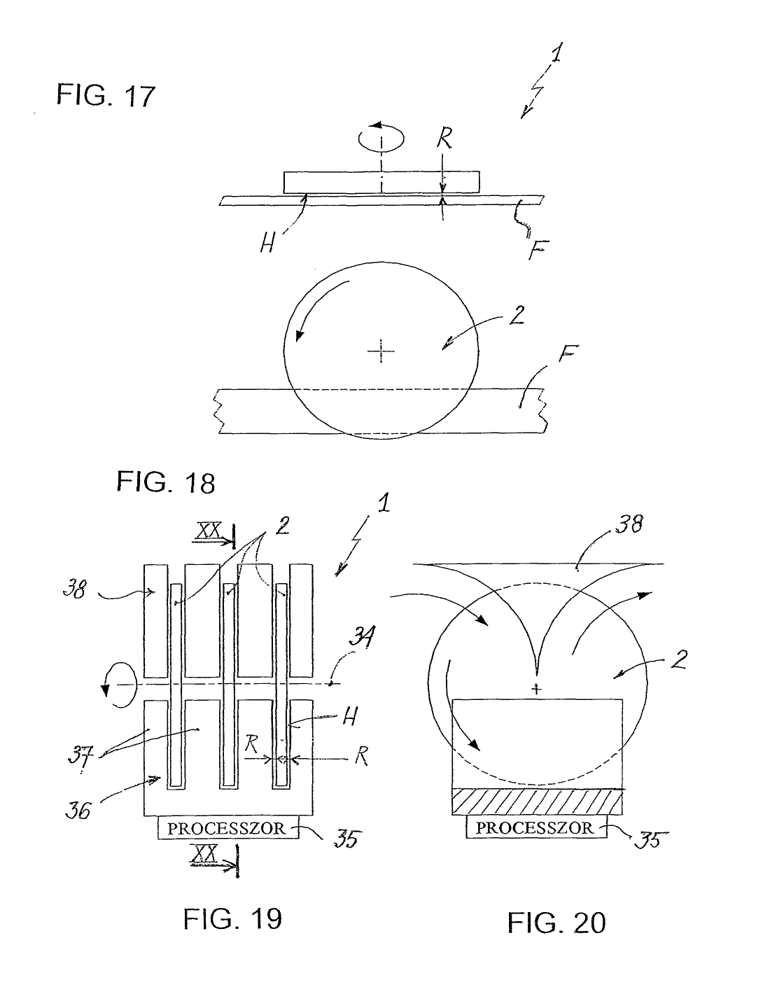

FIGS. 17 and 18 show an outline of a further embodiment of a heat-transferring apparatus 1 according to the invention, where a flat disc is applied as a rotor 2, with its lower front surface (heat-receiving surface) participating in the heat transfer according to the invention. For the sake of analogy with the embodiments presented above, this was indicated here as a “delimiting mantle H”; it is arranged at an interval corresponding to the gap R from the material layer (as heat-discharging surface) to be cooled, which is a band-type product, e.g. a plastic foil F.

It can be clearly observed on the top view presented in FIG. 18; that the foil F to be cooled is arranged below approx. the external half of the delimiting mantle H of the rotor 2, since—as mentioned above—the peripheral speed of each point of the delimiting mantle H formed as a front plate increases linearly according to the radius. This solution differs from heat transfer through a cylindrical mantle only in the aspect of these geometrical differences. In practice, of course, the rule is always to apply the solution which can best correspond to the actual user's demands.

In the arrangement according to FIGS. 17 and 18, the plain front surface is the delimiting mantle H to perform heat transfer as regards the rotor 2 shaped as a thin disc. In a given case, more than one disc-type rotors can be placed beside each other along the foil track. At a multi-disc solution, the delimiting mantle surface for heat transfer is also multiplied accordingly.

A multi-disc example is shown in FIGS. 19 and 20 for the theoretical outline of a heat-transferring apparatus 1 according to the invention, intended for cooling a solid material layer, e.g. a computer processor 35. In the present case, three coaxial disc-like rotors 2 are applied in order to increase heat-transferring surfaces, which have a common rotary shaft 34, and where both plain front surfaces act as delimiting mantles H (heat-receiving surfaces) for heat transfer.

In FIG. 19 a ribbed element 36 is arranged above the processor 35 to be cooled, with the delimiting mantles H (shaped as plain front plates) of the rotors 2 being arranged at an interval corresponding to a gap R from its cooling ribs 37. At an upper part of the rotors 2, separation plates 38 are arranged on both sides; they are adjusted compared to the delimiting mantle H so that they should separate, to the highest degree possible, the heated air boundary layer of the delimiting mantles H of the rotors 2, thus the rotating delimiting mantles H should take in fresh air on an ongoing basis into the gaps R for an even more efficient heat transfer. The cooling ribs 37 can be made of a material of good heat conduction properties, e.g. aluminum.

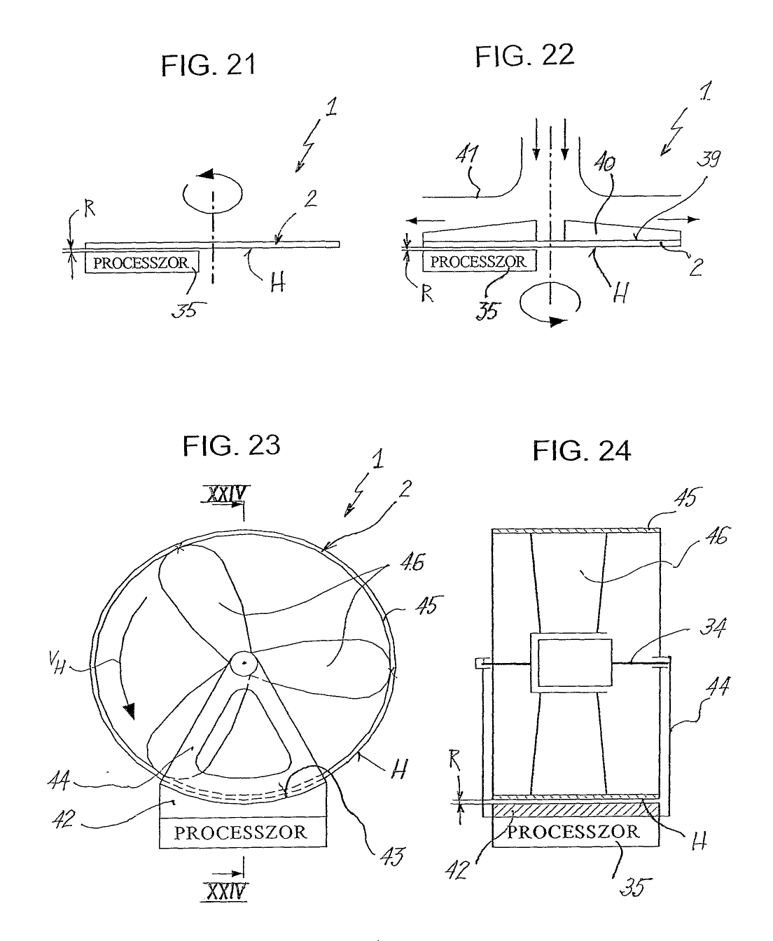

FIG. 21 illustrates a simplified embodiment of the heat-transferring apparatus 1 according to the invention intended for the operational cooling of an electronic building block, e.g. a processor 35 (which is to be understood as solid material layer to be cooled). Here, a single disc-type rotor 2 is applied, whose lower plain front surface—indicated as a delimiting mantle H—is arranged at an interval corresponding to a gap R from the upper surface (heat-discharging surface) of the processor 35 to be cooled, meaning that here cooling ribs are omitted and the plain top surface of the processor 35 is cooled directly by air flow, as discussed above.

An improved version of FIG. 21 is shown in FIG. 22. The only difference in the heat-transferring apparatus 1 for processor cooling illustrated here is that an upper front plate 39 of the rotor 2 is equipped with a multitude of radial blades 40 to forward a medium. Thereby, on the one hand, the rotor 2 is cooled by this air flow, which increases the efficiency of heat transfer; on the other hand, warmed air is blown away from the proximity of the rotor 2 and the processor 35 to be cooled, meaning that the rotor 2 operates as a “fan” with axial inlet by applying an adequate housing 41. This solution becomes even more efficient by using the additional plates for boundary layer separation (not illustrated).

A further embodiment of a heat-transferring apparatus 1 according to the invention is shown in FIGS. 23 and 24, which is also designed for cooling a processor 35.

We refer to the prior art in this respect. As it is known, the traditional processor coolers are characterized by the fact that relatively large cooling ribs are connected to the surface of processors. Heat goes a long way before it gets from the processor surface to the surface of the cooling ribs, wherefrom it is removed by fan air through heat transfer followed by heat conveyance. Although these cooling ribs have good heat conduction properties, cooling efficiency is very low due to the long way of heat conduction as the speed of air is relatively low, and flow conditions are unfavourable due to the surface features. Therefore, heat transfer is of relatively low efficiency as a whole.

A further embodiment of the heat-transferring apparatus 1 according to the invention as shown in FIGS. 23 and 24 completely eliminates the deficiencies of traditional processor coolers listed above. Here a relatively thin heat-receiving element 42 is placed on an upper surface (heat-discharging surface) of the processor 35 to be cooled, thereby the heat conduction route is much shorter. An upper arched surface 43 of the heat-receiving element 42 is located at an interval corresponding to a gap R from a cylindrical delimiting mantle H of a rotor 2, constituting a heat-receiving surface here (see FIG. 24).

In the present case, a rotary shaft 34 of the rotor 2 is embedded rotatable in a frame 44 connected to the heat-receiving element 42. The rotor 2 is provided with a rotary drive (not shown). The delimiting mantle H of the rotor 2 rotates a high peripheral speed v_{H}, thus the relative speed difference is great in the relatively narrow gap R; therefore, as a result of a strong medium flow for heat transfer, the value of the heat transfer coefficient is also high (as explained in detail by way of examples above).

This embodiment can be characterized by a further special feature that a rotating cylinder body 45 of the rotor 2 is a thin-walled metal tube, whose radial supporting spokes 46 are shaped like “fan blades”. The importance of the thin-walled body 45 lies in the fact that that the rotor 2 can emit heat inside as well. As a result of fan-type spokes 46, axial air flow is generated both inside and outside the rotor 2, by the quantity of air drawn by it. Thus, air exchange is also continuous inside the rotor 2; and along its external delimiting mantle H. So air flows for heat transfer are generated in two directions, that is, in axial and radial directions, perpendicular to each other, as a result of the medium flows generated by the rotation of the rotor 2 and its spokes 46.

In the course of our experiments, the peripheral speed v_{H} of the delimiting mantle H of the rotor 2 was selected to be 800 m/min, and the size of the gap R to be 0.2 mm; furthermore, the tube body 45 and the spokes 46 of the rotor 2 were made of aluminum.

Inside, the blade-like spokes 46 of the rotor 2 take out the boundary layer of the heat transfer surface; and outside, the heated boundary layer cool down as a result of bi-directional air flow, partly getting removed and exchanged; besides, the tube-like rotor body 45 also cools down. Therefore, in this embodiment heat is conducted along a much shorter route; much more intensive heat transfer can be ensured on the heat-discharging surface; and the heat is removed very rapidly from the surroundings of this surface.

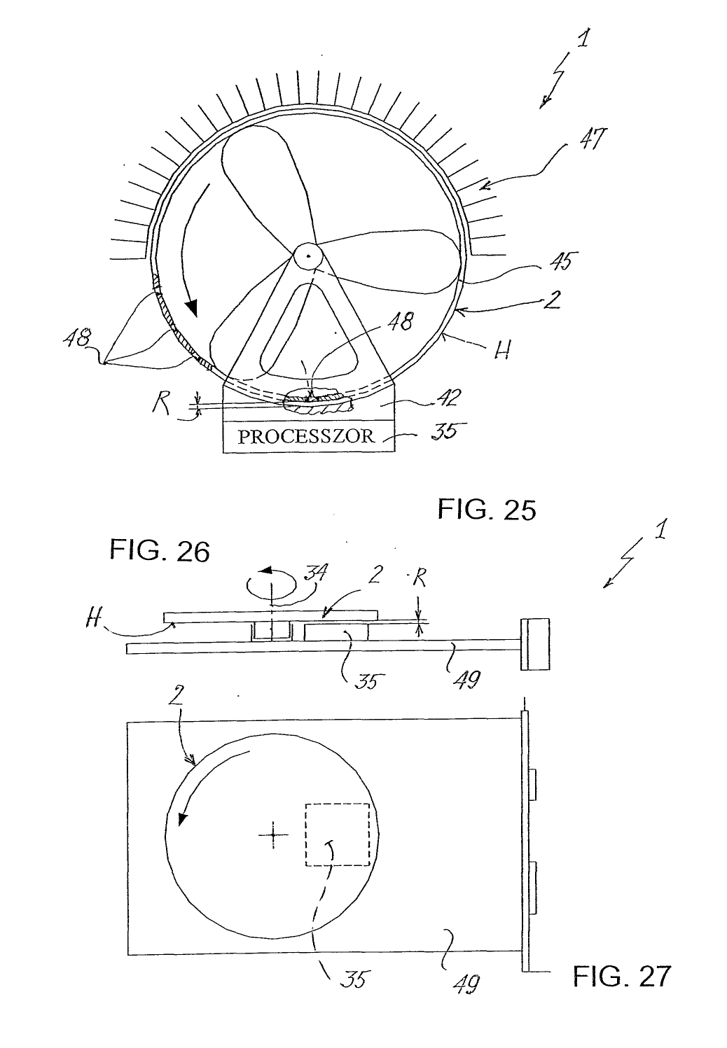

In a given case, the arrangement according to FIGS. 23 and 24 can be provided with an additional heat-transferring unit; such an embodiment of the heat-transferring apparatus 1 according to the invention is illustrated in FIG. 25. The single difference of this embodiment—compared to FIG. 23—is that an additional heat-transferring unit 47 is used for assisting in separating and exchanging the boundary air layer of a delimiting mantle H of a rotor 2.

The additional heat-transferring unit 47 comprises a cylindrical mantel with external cooling ribs, and said cylindrical mantle is arranged from the delimiting mantle H of the rotor 2 with a small gap. On the other hand, as the additional heat-transferring unit 47 takes over the heat quantity conveyed by the rotor 2 and the boundary air layer, it makes cooling even more intensive.

In FIG. 25, the delimiting mantle H is partly broken out in order to illustrate a multitude of perforations 48, which, in the present case, are shaped as circular holes along the entire delimiting mantle H of the cylinder body 45 of the rotor 2. Obviously, the perforations 48 can be of any other shape and their number and arrangement is discretional. Through the perforations 48, additional (e.g. radial or inclined) cooling air flows can be generated to the main medium flow in the gap R through the internal space of the drum-like rotor 2, thereby turbulence can be increased in the main medium flow. On the other hand, the main medium (air) flow can be refreshed consequently the efficiency of heat transfer can be further improved.

As known, processors of video cards require cooling as well; this is a special case of heat transfer compared to the previous ones both in terms of location and space requirement. The processor is located, in a known manner, on a video card with approx. 2 cm of free space as it is followed by a subsequent card (it may also occur that the adjacent card is left out, but then a much smaller space is available than in the case of a central processor.

FIGS. 26 and 27 show a further embodiment of the heat-transfer apparatus 1 according to the invention, designed for cooling a processor 35 of a video card 49; its theoretical arrangement and mode of operation substantially correspond to the embodiment presented in connection with FIG. 21.

According to FIGS. 26 and 27, this small processor 35 to be cooled is fixed in a known manner to the video card 49 acting as a carrier element. Above the processor 35 to be cooled, a disc-type rotor 2 of the apparatus 1 is arranged at an interval corresponding to a gap R. A lower front surface (heat-receiving surface) of the rotor 2 constitutes a delimiting mantle H according to the invention. In the present case, a rotary shaft 34 of the rotor 2 is embedded rotatable in the video card 45, itself, but this can also be achieved by a separate supporting frame (not illustrated).

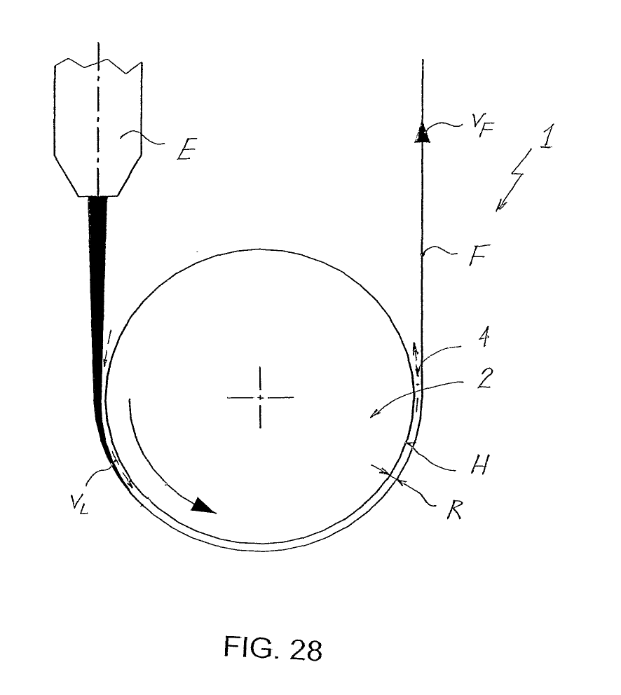

Finally, FIG. 28 shows the last illustrated embodiment of the heat-transferring apparatus 1 according to the invention designed again for cooling a plain foil F. This arrangement substantially corresponds to the embodiment according to FIG. 8, therefore the same reference signs were applied, but a more detailed description is omitted. Here it is intended to demonstrate in particular that the foil F just exiting from a known extruder die E is still in a plastic state (it constitutes the plastic material layer), which is then cooled down by the heat transfer in the manner presented above, thereby the foil F is stabilized in its final size.

In summary, let us emphasize that the heat transfer technology according to the present invention can be applied in practice in the widest range possible. By way of the proposed improved heat transfer, fixed units (e.g. products, structural units, processors, etc.) can be heated or cooled by it, but in a given case, constantly or intermittently moving (e.g. rotating or alternating) bodies (e.g. bands, foils and other strip-like products).

An important feature for the operation of the solution according to the invention is that the gap R admitting the medium flow for heat transfer should be selected as small as possible between the heat-receiving and heat-discharging surfaces. Generally speaking, the term “as small as possible” is to be interpreted in a way that the size of the gap R should be smaller than the aggregate of the thickness of the boundary medium layers generated along both relatively moving surfaces; that is, this is considered to be an arrangement approaching the optimum. Thus, while the heat transfer surfaces pass along each other, the boundary medium layers touch and mix with each other, and this is what ensures surprisingly intensive heat transfer (the concept ‘boundary medium layer’ is known for an expert having ordinary skill in the art, therefore no detailed explanation thereof is included.)

Finally, let us emphasize that within the claimed scope of protection applied for, the heat transfer technology according to the invention can be applied in practice in the widest possible range, in many other versions and combinations. Let us mention as an example that in a given case, the guide rollers 23 according to FIG. 15 can be formed in the same way as the tempering cylinder 19/rotor 2 of FIG. 13; in order to do so, it must be equipped accordingly with a rotary drive and a heating/cooling unit. In such a case, a gap R is also formed between the guide roller 23 and the foil F, including the tempering medium flow circulating in it, with the advantages above. However, the cylindrical mantle H of the tempering cylinder 19 or of the rotor 2 in other embodiments can itself be curved and rounded or doubly conical, similarly to the design of the guide roller 23 of FIG. 15, for the purposes of better foil guidance, smoothing and de-creasing, and pulling apart.

On the other hand, although air was mainly mentioned as a medium of heat transfer in the above embodiments, the process according to the invention can be implemented by any other gaseous mediums, such as nitrogen, neon, helium, or argon as well; moreover, in a given case, the medium for heat transfer can be a fluid as well, e.g. water or other material capable to flow, e.g. sand, or any mix or combination thereof.

It has been mentioned in the introduction that the technology according to the invention is intended for heat transfer between the heat transfer surface of a solid body (relatively moved body e.g. rotor, disc, cylinder) and a material layer—by applying an additional medium flow for heat transfer—, which material layer may contain solid material (solid structural element, electronic unit, e.g. processor, or other product e.g. band, foil, etc.), or plastic material (paper industry pulp, freshly extruded band or string-type plastic products), or fluid substances, e.g. intermittent or constant paint layer, or a mix thereof, and in a given case the material layer may also contain gaseous particles.

In all embodiments presented above, the delimiting mantle H according to the invention, acting as heat-receiving or heat-discharging surface, can be provided with at least one nest, preferably groove and/or at least one extension, preferably a rib and/or at least one perforation. Consequently, the delimiting mantle H need not necessarily be a contiguous e.g. plain or arched surface; it can be divided by extensions and dents. Furthermore, the delimiting mantle H can be formed e.g. from front surfaces of one or more moved blade-type elements arranged at circumferential intervals.

As regards FIG. 25, it has been mentioned above that through the of perforations 48, additional (radial or inclined) cooling or heating air flows can be allotted to the main medium flow in the gap R. Thereby the turbulence of the main heat-transferring medium flow can be increased; on the other hand, the main medium flow can be refreshed, consequently thereby the efficiency of heat transfer can be further improved.

### LIST OF REFERENCE CHARACTERS

1 Apparatus for heat transfer
2 Rotor
3 Housing
4 Heat-transferring medium flow
5 Inlet chamber
6 Heat-transferring medium source
7 Rotary drive
8 Friction wheel
9 Shaft
10 Driving motor
11 Internal mantle surface (of the rotor 2)
11_{A} Ribs or grooves
12 Outlet
13 Radial ribs or grooves
14 Nozzle
15 External mantle (of the housing)
16 Inlet chamber
17 Arrow
18 Support element
19 Tempering cylinder
20 Paint layer
21 Arrow
22 Housing
23 Guide roller
24 Exhaust fan
25 Condenser
26 Arrow
27 Additional tempering unit
28 Nest
29 Mantle surface
30 Mantle surface
31 Splitting point
32 Span angle
33 Fluid charge
34 Rotary shaft
35 Material layer, e.g. solid unit (e.g. processor)
36 Ribbed element
37 Cooling ribs
38 Separation plate
39 Front plate
40 Blade
41 Housing
42 Heat-receiving element
43 Arched surface
44 Frame
45 Cylinder body
46 Spoke
47 Additional heat-transferring unit
48 Perforations
49 Video-card
E Extruder die
F Foil/Foil hose
H Delimiting mantle
O Axis
R; R₁ Gap
X Arrow
Y Slot
v_{F} Speed of foil (F)
v_{H} Speed of delimiting mantle (H)
v_{L} Speed of heat-transferring medium flow (4)

1. Process for heat transfer between a solid object and a material layer comprising solid and/or liquid material, and in a given case gaseous particles, by using a heat-transferring medium flow for the heat transfer between a heat-receiving surface of the solid object or the material layer and a heat-discharging surface of the material layer or the solid object, wherein said heat-receiving and heat-discharging surfaces being arranged with a distance from each other, characterized by the steps of: a) arranging the heat-discharging surface with the distance from the heat-receiving surface to provide with a predetermined gap (R) for the heat-transferring medium flow (4); b) generating a predetermined speed difference (Δᵥ) between the heat-receiving and a heat-discharging surfaces by providing a relative movement of the heat-receiving surface and/or the heat-discharging surface; c) increasing in a predetermined manner the speed (v_{L}) of the heat-transferring medium flow (4) in the gap (R) compared to the speed of the heat-receiving and/or the heat-sending surfaces (v_{H} and/or v_{F}) by means of said speed difference (Δᵥ); d) maintaining a turbulent character of the heat-transferring medium flow (4) in the gap (R); e) carrying out the heat transfer between the heat-receiving and the heat-discharging surfaces at least mainly by the turbulent heat-transferring medium flow (4).

2. Process as claimed in claim 1, characterized by the steps of using as material layer a strip-like product, such as foil, especially blown foil hoses (F) just extruded from thermoplastics; tempering an external and/or internal surface(s)—as the heat-receiving or heat-discharging surface(s) of the foil (F) by the turbulent heat-transferring medium flow (4); maintaining the turbulent heat-transferring medium flow (4) in the gap (R) between the product, preferably the foil (F) and a delimiting mantle (H) of the solid object, preferably rotor (2), forming the heat-receiving or heat-discharging surface thereof; actuating the delimiting mantle (H) of the solid object, preferably rotor (2) in a relative movement of a predetermined speed (v_{H}) compared to the material layer, preferably the foil (F).

3. Process as claimed in claim 2, characterized by the steps of carrying out the predetermined relative movement of the delimiting mantle (H) of the solid object, preferably the rotor (2) by rotation; and forming the delimiting mantle (H) at least partly on a mantle surface and/or face surface of the rotor (2).

4. Process as claimed in claim 2, characterized by the additional steps of arranging the delimiting mantle (H) of said rotor (2) in annular form inside and/or outside around the foil hose (F) just exiting from an extruder die (E) and being blown-up, preferably at initial part of a cylindrical—following a conically extended—and still not stabilized section of the foil hose (F), with the radial distance according to the predetermined gap (R); and forcing the turbulent heat-transferring medium flow (4) in the gap (R) in at least one spiral whirling motion along an internal and/or external mantle surface of the foil hose (F).

5. Process as claimed in claim 2, characterized by the step of selecting the value of the peripheral speed (v_{H}) of the delimiting mantle (H) of the rotor (2) to multiple, preferably at least fivefold of the speed of the heat-transferring medium flow (4).

6. Process as claimed in claim 4, characterized by setting the size of the gap (R) by selecting the speed (v_{L}) of the turbulent heat-transferring medium flow (4) in the gap (R); and preferably at the same time calibrating a final diameter of the blown foil hose (F) by the turbulent heat-transferring medium flow (4).

7. Process as claimed in claim 2, characterized by forming the delimiting mantle (H) exclusively on a cylindrical mantle surface of the rotor (2); and providing said mantle (H) of the rotor (2) with means for increasing axial and/or tangential components of the speed (v_{L}) of the turbulent heat-transferring medium flow (4), such as grooves and/or ribs (H_{A}) and/or holes or perforations (48).

8. Process as claimed in claim 7, characterized by embedding the rotor (2) at least partly in a pneumatic bearing; and using compressed air of said pneumatic bearing additionally as secondary heat-transferring medium.

9. Process as claimed in claim 1, characterized by guiding the turbulent heat-transferring medium flow (4) exclusively in the gap (R) between the heat-receiving and the heat-discharging surfaces, preferably between the delimiting mantle (H) and the foil (F).

10. Process as claimed in claim 2, characterized by using as material of the heat-transferring medium flow (4) at least one gaseous medium, mainly air, or at least one fluid, mainly water, or any other material capable to flow, e.g. sand, or any mixture or combination thereof.

11. Process as claimed in claim 2, characterized by setting the size of the gap (R) receiving the turbulent heat-transferring medium flow (4) for tempering the thermoplastic foil hose (F) preferably maximum at the value of 1.0 mm.

12. Process as claimed in claim 2, characterized by applying said heat transfer process for drying the material layer, mainly the foil (F) after its printing, and then preferably for re-cooling the printed foil (F) after the drying step.

13. Process as claimed in claim 1, characterized by applying said heat transfer process for cooling the material layer containing for example at least one solid structural part to be protected against overheating during its operation, preferably electronic unit, such as processor (35).

14. Apparatus for heat transfer between a solid object and a material layer comprising solid and/or liquid material, and in a given case gaseous particles, mainly for carrying out the process as claimed in any of previous claims, by using a heat-transferring medium flow for the heat transfer between a heat-receiving surface of the solid object or the material layer and a heat-discharging surface of the material layer or the solid object, wherein said heat-receiving and heat-discharging surfaces are arranged with a distance from each other, forming a gap there-between, and said apparatus comprises a medium source for feeding the heat-transferring medium flow into the gap, characterized in that the heat-receiving or heat-discharging surface of the solid object, preferably a delimiting mantle (H), being in contact with the heat-transferring medium flow (4) is formed on a structural part, preferably on a rotor (2) of the apparatus (1), which is relatively movable, preferably rotatable arranged in a housing (3; 22) of the apparatus (1) compared to the heat-discharging or heat-receiving surface of the material layer, preferably foil (F), being in contact with the heat-transferring medium flow (4); said structural part, preferably the rotor (2) is in driving connection with a drive, preferably a rotary drive (7) of preferably controllable speed; furthermore it is provided with a heat-removing unit for re-moving a heat content of the rotor (2) and/or the housing (7;22) from the apparatus (1), which heat content was received by heat transfer from the delimiting mantle (H) and/or with a heating unit for generating tempering heat for the delimiting mantle (H).

15. Apparatus as claimed in claim 14, characterized in that the delimiting mantle (H)—serving as heat-receiving surface or heat-discharging surface—is formed on a mantle surface and/or on a head surface of the rotor (2).

16. Apparatus as claimed in claim 14, characterized in that the delimiting mantle (H)—serving as heat-receiving surface or heat-discharging surface—is formed exclusively on a substantially cylindrical mantle surface of the rotor (2), and said delimiting mantle (H) is provided with means for increasing axial and/or tangential components of the speed (v_{L}) of the turbulent heat-transferring medium flow (4), such as grooves and/or ribs (HA) and/or holes or perforations (48).

17. Apparatus as claimed in claim 14, characterized in that the rotor (2) is embedded in the housing (3) at least partly in a pneumatic bearing, which is connected to an additional compressed air source, with individual control.

18. Apparatus as claimed in claim 14, characterized in that the rotor (2) has a ring-like design, wherein an internal mantle surface (11) thereof is provided with blade-like ribs (13) or grooves cooperating with at least one nozzle (14) connected to a controllable compressed air source, and forming thereby a pneumatic rotary drive (7).

19. Apparatus as claimed in claim 14, characterized in that the rotary drive (7) of the rotor (2) is a friction drive comprising at least one friction wheel (8) being in frictional driving connection with the rotor (2).

20. Apparatus as claimed in claim 17, characterized in that the housing (3) is provided with inlet chambers (5; 16) in its sections being adjacent to the rotor (2) for the pneumatic bearing of the rotor (2), and each inlet chamber (5; 16) is connected to its own compressed air source having individual control.

21. Apparatus as claimed in claim 14, characterized in that the heat-transferring apparatus (1) is formed as an improved drying device for the material layer, preferably printed thermoplastic extruded foil (F), comprising at least one tempering cylinder (19), which is rotatable arranged in a housing (22) as rotor (2) along a track of freshly printed foil (F), wherein the delimiting mantle (H) of the tempering cylinder (19) is arranged with the predetermined gap (R) receiving the heat-transferring medium flow (4), from the material layer, preferably from the printed side of the foil (F); and along a track of foil (F) the tempering cylinder (19) as rotor (2) is preceded and succeeded by at least one guide roller (23).

22. Apparatus as claimed in claim 21, characterized in that the apparatus (1) is provided with at least two of said tempering cylinders (19) as rotors (2) along a track of printed foil (F), each of them is associated with two of said guide rollers (23); and at least one of the tempering cylinders (19) can be used as drying device, and at least one other tempering cylinder (19) can be used as foil re-cooling device.

23. Apparatus as claimed in claim 14, characterized in that the one side of the material layer, preferably foil (F) to be tempered is associate with at least one of said tempering cylinder (19) designed as rotor (2), and an additional, preferably cool-able and/or heat-able tempering unit 27 is provided on the opposite side of the material layer, preferably foil (F), which is arranged at a predetermined interval corresponding to a gap Ri from the foil F, for receiving an other heat-transferring medium flow.

24. Apparatus as claimed in claim 14, characterized in that at least one of the rotors (2) as tempering cylinders (19) and/or the guide rollers (23) has a mantle surface (29, 30) formed like a barrel, or with two symmetric surfaces of a truncated cone, whose diameter is decreasing outwards.

25. Apparatus as claimed in claim 14, characterized in that the solid material layer having said heat-discharging surface and being arranged with said gap (R) from the heat-receiving surface of the solid object, preferably from the delimiting mantle (H) of the rotor (2), may contain any structural unit to be protected against overheating during its operation, preferably electronic unit to be cooled, such as processor (35).

26. Apparatus as claimed in claim 14, characterized in that said heat-transferring delimiting mantle (H) of the rotor (2) is provided with means for increasing axial and/or tangential speed-components of the turbulent heat-transferring medium flow (4), such as grooves and/or ribs (H_{A}) and/or holes or perforations (48).
